(19) United States
(12) Patent Application Publication
(10) Pub. No.: US 2013/0282583 A1
(43) Pub. Date: Oct. 24, 2013

(54) FRAUD DETECTION SYSTEM RULE PROFILE INTERACTION

(71) Applicants: Cory H. Siddens, Mountain View, CA (US); B. Scott Boding, Mountain View, CA (US)

(72) Inventors: Cory H. Siddens, Mountain View, CA (US); B. Scott Boding, Mountain View, CA (US)

(21) Appl. No.: 13/866,927

(22) Filed: Apr. 19, 2013

Related U.S. Application Data
(60) Provisional application No. 61/636,352, filed on Apr. 20, 2012.

(51) Int. Cl. G06Q 20/40

(52) U.S. Cl. CPC G06Q 20/4016
USPC 705/44

(57) ABSTRACT

Embodiments of the invention generally relate to methods and systems for generating rule profile reports, the rule profile reports comprising statistical data regarding the performance of rules. One embodiment of the invention discloses a method for generating a rule profile report. The method comprises determining, by a processor, a rule profile, wherein the rule profile comprises a plurality of rules, and wherein each rule in the plurality of rules is associated with a plurality of rule outcomes, determining for the plurality of rules a plurality of rule outcome frequencies associated with the plurality of rule outcomes, wherein each rule outcome in the plurality of rule outcomes is associated with an outcome for a transaction, and providing, by the processor, the plurality of rule outcome frequencies.

### CROSS-REFERENCES TO RELATED APPLICATIONS

The present application is a non-provisional application of and claims priority to U.S. Provisional Application No. 61/636,352, filed on Apr. 20, 2012 (Attorney Docket No.: 79900-837751(021300USP1)), the entire contents of which are herein incorporated by reference for all purposes.

### BACKGROUND

Fraud rules are rules that may be used to automatically detect fraudulent activity. For example, fraud rules may be used to determine if a payment transaction is fraudulent or if a payment account has been compromised. Fraud rules may be evaluated at a payment account issuer, payment processing network, merchant processor, or acquirer. If a fraudulent transaction is detected, a fraud rule may reject a transaction, flag the transaction for human review, approved the transaction, or approve/reject and log the transaction.

For many merchants, effective fraud rules are an important way to prevent fraudulent transactions from occurring. Merchants may manually evaluate fraud rules; however, manual evaluation is undesirable for several reasons. For example, merchants may have a high transaction volume, which may make manual review of the fraud rule outcome for each transaction impractical. In addition, merchants may desire aggregate data regarding the distribution of fraud rule outcomes. Further, merchants may have many fraud rules, and manually identifying interactions between fraud rules may be difficult.

Embodiments of the invention address these and other problems.

### SUMMARY

Embodiments of the invention generally relate to methods and systems for generating rule profile reports in a fraud detection system, the rule profile reports comprising statistical data regarding the performance of fraud rules.

One embodiment of the invention discloses a method for generating a rule profile report. The method comprises determining, by a processor, a rule profile, wherein the rule profile comprises a plurality of rules, and wherein each rule in the plurality of rules is associated with a plurality of rule outcomes, determining for the plurality of rules a plurality of rule outcome frequencies associated with the plurality of rule outcomes, wherein each rule outcome in the plurality of rule outcomes is associated with an outcome for a transaction, and providing, by the processor, the plurality of rule outcome frequencies.

One embodiment of the invention discloses a server computer. The server computer comprises a processor and a non-transitory computer-readable storage medium, comprising code executable by the processor for implementing a method comprising determining, by a processor, a rule profile, wherein the rule profile comprises a plurality of rules, and wherein each rule in the plurality of rules is associated with a plurality of rule outcomes, determining for the plurality of rules a plurality of rule outcome frequencies associated with the plurality of rule outcomes, wherein each rule outcome in the plurality of rule outcomes is associated with an outcome for a transaction, and providing, by the processor, the plurality of rule outcome frequencies.

One embodiment of the invention discloses a computer-implemented method for generating a candidate rule. The method comprises sending, by a processor, one or more search parameters, wherein the search parameters are used to determine a rule profile, wherein the rule profile comprises a plurality of rules, and wherein each rule in the plurality of rules is associated with a plurality of rule outcomes, receiving, by the processor, a plurality of rule outcome frequencies associated with the plurality of rule outcomes, wherein each rule outcome in the plurality of rule outcomes is associated with an outcome of a transaction, and displaying, by the processor, the plurality of rules and rule outcome frequencies.

One embodiment of the invention discloses a server computer. The server computer comprises a processor and a non-transitory computer-readable storage medium, comprising code executable by the processor for implementing a method comprising sending, by a processor, one or more search parameters, wherein the search parameters are used to determine a rule profile, wherein the rule profile comprises a plurality of rules, and wherein each rule in the plurality of rules is associated with a plurality of rule outcomes, receiving, by the processor, a plurality of rule outcome frequencies associated with the plurality of rule outcomes, wherein each rule outcome in the plurality of rule outcomes is associated with an outcome of a transaction, and displaying, by the processor, the plurality of rules and rule outcome frequencies.

Further details regarding embodiments of the invention can be found in the Detailed Description and the Figures.

### BRIEF DESCRIPTION OF THE DRAWINGS

FIG. 1 shows a system according to an embodiment of the invention.

FIG. 2 shows an exemplary fraud detection system that may be used in embodiments of the invention.

FIG. 3 illustrates an exemplary merchant processor computer according to some embodiments of the invention.

FIG. 4 illustrates an exemplary payment processing network according to some embodiments of the invention.

FIG. 5 shows a method for processing a transaction through a system.

FIG. 6 shows a fraud detection system decision process for evaluating fraud rules to determine a transaction outcome for a transaction.

FIG. 7 shows a method to request, display, and use a rule profile report.

FIG. 8 shows a method for a user to send search parameters to fraud detection system using a merchant client computer.

FIG. 9 shows an exemplary user interface for logging into fraud detection system in accordance with some embodiments of the invention.

FIG. 10 shows a reports home page for selecting a reports option and accepting search parameters from a user.

FIG. 11 shows a method of generating a rule profile report using a fraud detection system and providing the report to a user.

FIG. 12 illustrates an exemplary rule profile report generated by a fraud detection system using search parameters specified by a user according to one embodiment of the invention.

FIG. 13 depicts an exemplary summarized rule profile report.

FIG. 14 shows a method of reviewing transactions associated with a rule outcome or rule outcome disposition.

FIG. 15 shows an exemplary transaction results interface.

FIG. 16 shows a method to request transaction details for a transaction

FIG. 17 shows a transaction details interface according to some embodiments of the invention.

FIG. 18 shows an example of a payment device in the form of a card.

FIG. 19 shows an exemplary computer apparatus.

### DETAILED DESCRIPTION

Prior to discussing embodiments of the invention, description of some terms may be helpful in understanding embodiments of the invention.

The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

An “access device” may include any suitable device for communicating with merchant and for interacting with a portable consumer device. An access device can be in any suitable location such as at the same location as a merchant. An access device may be in any suitable form. Some examples of access devices include POS terminals, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. Typically, an access device may use any suitable contact or contactless mode of operation to electronically transmit or receive data from a portable consumer device.

The term “transaction details” may include any data, information, or attributes regarding a transaction. For example, in some embodiments, transaction details may describe a payment transaction. In some such embodiments, transaction details may comprise a transaction date, a transaction identifier, consumer data, merchant data, payment data, etc. A “request for transaction details” may include a command with search parameters equal to and/or encompassing the associated transaction for which transaction details are desired.

The term “authorization status” of a transaction may include any indicator of the payment authorization of the transaction, or as otherwise known in the art. For example, in some embodiments, the authorization status may indicate that a transaction is accepted, rejected, or in review. In some embodiments, the authorization status may be associated with an authorization response message sent from an issuer, acquirer, or other entity.

A “search parameter” may include information used to determine one or more transactions, or as otherwise known in the art. In some embodiments, search parameters may include a date range, a transaction amount, an issuer, or any other suitable attribute of a transaction. For example, a search parameter may be to retrieve transactions which occurred in the previous 24 hours. A search parameter may be used to determine a rule profile, such as through keywords, numerical range matching, or otherwise.

A “transaction total” may indicate the total number of transactions determined by one or more search parameters. For example, in an embodiment relating to a fraud detection system, the transaction total may be subset of processed transactions determined using the search parameters. Alternately, the transaction total may be the total number of transactions processed by the fraud detection system.

The term “transaction outcome” may include any determination made in relation to a transaction. In some embodiments, the transaction outcome may be one of a plurality of pre-defined transaction outcomes associated with the transaction. In some embodiments, the transaction outcome may indicate an action to be performed.

For example, in one embodiment relating to a fraud detection system, transaction outcomes may be “Accepted”, “Rejected”, and “Review”. The term “Rejected” may indicate that the transaction should be rejected by the fraud detection system. The term “Review” may indicate that the transaction should be manually accepted or rejected based on a human review of the transaction. The term “Accepted” may indicate that the transaction should be accepted by the fraud detection system. In various embodiments, other transaction outcomes or other meanings of these transaction outcomes may be used.

A “total outcome frequency” may include the frequency of total transactions associated with a transaction outcome. In some embodiments, the total outcome frequency may be a “total outcome frequency percentage”, which may include a percentage of transactions in the transaction total which are associated with the transaction outcome. For example, if the transaction total is 1000, and 250 of those transactions are associated with a transaction outcome of “Review”, then the total outcome frequency percentage for “Review” may be 25%. In some embodiments, the total outcome frequency may be a “total outcome frequency value”, which may include a total number of transactions which are associated with the transaction outcome. For example, if the transaction total is 1000, and 250 of those transactions are associated with a transaction outcome of “Accepted”, then the total outcome frequency value for “Accepted” may be 250. In some embodiments, the sum of all total outcome frequency values may equal the transaction total.

A “rule” may include any procedure or definition used to determine a rule outcome for a transaction, or as otherwise known in the art. In some embodiments, the rule may comprise a rule condition and a rule outcome. A “rule condition” may specify a logical expression describing the circumstances under which the outcome is determined for the rule. For example, a rule condition may specify transactions with a transaction amount over $500 and with an inconsistent geo-location at which the transaction was conducted. Because this relates to preventing fraud, it may be considered a “fraud rule.” An example rule outcome may be “rejected”. A rule corresponding to the aforementioned rule condition and rule outcome would reject transactions with a transaction amount over $500 and an inconsistent geo-location. In another example, a rule may specify that card present transactions with a card verification value (CVV) submitted should always have a rule outcome of “approved”. Rules may use any suitable transaction attribute or non-transaction attribute to determine a rule outcome for a transaction. In some embodiments, rules may have multiple rule conditions associated with different rule outcomes.

A “rule outcome” of or for a transaction may represent an outcome determined by a rule for a transaction, or as otherwise known in the art. In some embodiments, a rule outcome may be one of a plurality of pre-defined transaction outcomes associated with the transaction. However, a rule outcome associated with a transaction may not necessarily be the transaction outcome for the transaction. In some embodiments, a rule may not determine any rule outcome for a transaction. A “request for transactions associated with a rule outcome” may include a command with search parameters equal to and/or encompassing the specified rule outcome.

In some embodiments, one or more rule outcomes may be used to determine the transaction outcome for a transaction. In one example, in an embodiment relating to a fraud detection system, the fraud detection system may comprise 4 rules. For a transaction, two of the rules may determine a rule outcome of ‘Accepted’, one rule may not determine any rule outcome, and the fourth rule may determine a rule outcome of ‘Rejected’. In some embodiments, the transaction outcome for the transaction may be ‘Rejected’, because a transaction outcome may be “Rejected” if at least one of the rule outcomes is ‘Rejected’. In various embodiments, a transaction outcome may be determined from rule outcomes using any other suitable method.

A “rule outcome disposition” may represent the final disposition or result associated with a transaction, or as otherwise known in the art. In some embodiments, a rule outcome disposition may be one of a plurality of pre-defined rule outcome dispositions associated with the transaction.

For example, in one embodiment relating to fraud rules, the fraud rule outcome dispositions may be determined 90 days after the transaction occurred in order for the consumer to identify the transaction as fraudulent and report the transaction to the issuer. In some embodiments, fraud rule outcome dispositions may be “Accepted” or “Rejected”. The term “Accepted” may indicate that the transaction was non-fraudulent (e.g., confirmed by the consumer). The term “Rejected” may indicate that the transaction was determined to be fraudulent (e.g., the consumer called the issuer to report the transaction as fraudulent).

A “rule outcome frequency” may include the frequency of transactions associated with a rule outcome or as otherwise known in the art. The frequency may be with respect to a number of times that an associated rule has been applied, a total number of transactions, a period of time, or otherwise. In some embodiments, the rule outcome frequency may be a “rule outcome frequency percentage”, which may include a percentage of transactions that are associated with the rule outcome. For example, if a rule is included in a profile transaction total is 1000, and 25 of those transactions are associated with a rule outcome of “Force Accepted”, then the rule outcome frequency percentage for “Force Accepted” may be 2.5%. In some embodiments, the rule outcome frequency may be a “rule outcome frequency value”, which may include a total number of transactions which are associated with the rule outcome. For example, if there are 1000 total transactions, and 25 of those transactions are associated with a rule outcome of “Rejected”, then the rule outcome frequency value for “Rejected” may be 25.

A “rule outcome disposition frequency” may include the frequency of transactions associated with a rule outcome disposition, or as otherwise known in the art. The frequency may be with respect to a number of times that an associated rule has been applied, a number of times that an associated rule disposition has been encountered, a total number of transactions, a period of time, or otherwise. In some embodiments, a rule outcome disposition frequency may be measured in an analogous manner to a rule outcome frequency. For example, a “rule outcome disposition frequency percentage” may refer to a percentage of transactions associated with a rule outcome disposition. Similarly, a “rule outcome disposition frequency value” may refer to a total number of transactions associated with a rule outcome disposition.

A “rule profile” may include a grouping of rules or other profile or rules as known in the art. In some embodiments, the rule profile may indicate a group of rules which are defined by the same party. For example, a fraud detection system associated with a merchant may include a rule profile defined by a payment processing network, another rule profile defined by a merchant processor, and a third rule profile defined by the merchant. Because some of the underlying rules relate to fraud, the each rule profile may be referred to as a “fraud rule profile.” In some embodiments, rule profiles may also be used to group rules with some logical or hierarchical association. In one example, rules relating to the geo-location of a transaction may be included in a first rule profile. Rules relating to the transaction frequency of a transaction may be included in a second rule profile. In various embodiments, rule profiles may include any suitable number of rules. In some embodiments, a rule profile may correspond to a merchant. For example, rules defined by the merchant may be included in a merchant rule profile.

In some embodiments, a rule profile may also comprise an indication of which transactions should be evaluated by the rule profile. For example, in one embodiment, a first rule profile may evaluate transactions made using a credit card, and a second rule profile may evaluate transactions made using a debit card. In some embodiments, each transaction may be associated with a rule profile used to evaluate the transaction.

A “profile transaction total” may include an indication of the total number of transactions associated with a rule profile. Typically, the profile transaction total may be a subset of the transaction total indicating the number of transactions evaluated using the rule profile. For example, in one embodiment, if the transaction total is 2000, the profile transaction total for a profile may be 500, indicating that 500 transactions were evaluated using the rules in the rule profile. In some embodiments, the sum of all profile transaction totals may equal the transaction total.

A “profile outcome frequency” may include an indication of the frequency of transactions in the profile transaction total associated with a transaction outcome. In some embodiments, the profile outcome frequency may be a “profile outcome frequency percentage”, which may include the percentage of the profile transaction total which is associated with the transaction outcome. For example, if the profile transaction total is 500, and 250 of those transactions are associated with a transaction outcome of “Accepted”, then the profile outcome frequency percentage for “Accepted” may be 50%. In some embodiments, the profile outcome frequency may be a “profile outcome frequency value”, which may include a number of transaction in the profile transaction total which is associated with the transaction outcome. For example, if the profile transaction total for a profile is 500, and 250 of those transactions are associated with a transaction outcome of “Accepted”, then the transaction outcome frequency value for “Accepted” may be 250. In some embodiments, the sum of all profile outcome frequency values may equal the profile transaction total.

A “rule profile report” may include statistical information regarding the performance of one or more rule profiles. In some embodiments, the rule profile report may comprise a plurality of rule outcome frequencies associated with one or more rule outcomes for the rules in the rule profiles. The rule outcome frequencies may be included as rule outcome frequency percentages, rule outcome frequency values, or any other suitable metric. The rule profile report may be displayed in any suitable format, such as a graphical format, a tabular format, or a list format.

As used herein, the term “providing” may include sending, transmitting, making available on a web page, for downloading, through an application, displaying or rendering, or any other suitable method. In various embodiments of the invention, rule profiles, rule outcome frequencies, and rule outcome disposition frequencies may be provided in any suitable manner.

It should be noted that the terms above may be used specifically to relate to fraudulent transactions. For example, embodiments of the invention may specifically relate to a “fraud detection system”, “fraud rules”, “fraud rule outcomes”, “fraud rule parameters”, “rule output files”, normalized scores”, “candidate rules”, and “finalized rules”. It is also noted that the methods disclosed for embodiments of the invention may generally be applied in domains other than fraud rules.

Embodiments of the invention generally relate to methods and systems for generating rule profile reports, the rule profile reports comprising statistical data regarding the performance of rules. One embodiment of the invention discloses a method for generating a rule profile report. The method comprises determining, by a processor, a rule profile, wherein the rule profile comprises a plurality of rules, and wherein each rule in the plurality of rules is associated with a plurality of rule outcomes, determining for the plurality of rules a plurality of rule outcome frequencies associated with the plurality of rule outcomes, wherein each rule outcome in the plurality of rule outcomes is associated with an outcome for a transaction, and providing, by the processor, the plurality of rule outcome frequencies.

Embodiments of the invention provide for many technical advantages. For example, embodiments of the invention provide an efficient method for summarizing the performance of fraud rules. In practice, fraud rules may analyze thousands or millions of transactions per day. Manually reviewing rule outcomes for each transaction in order to determine the effectiveness of the fraud rules may be both time-consuming and complicated for a user of a fraud detection system. Embodiments of the invention allow for rule outcomes frequencies and rule outcome disposition frequencies to be tabulated, so that the user may be presented with the aggregate performance of each rule outcome and rule outcome disposition.

Providing a user with aggregate performance metrics facilitates the definition and evaluation of fraud rules. In one example, the user may notice that the rule outcome frequencies for a fraud rule do not match the rule outcome disposition frequencies for the fraud rule. For example, for a rule “transaction amounts greater than $500 indicates fraud”, the user may notice that the rule has a rule outcome frequency percentage for “Accepted” of 90%, and a rule outcome frequency percentage for “Rejected” of only 10%. In other words, a majority of the transactions rejected by the fraud rule are actually non-fraudulent transactions. This may indicate to the user that the fraud rule is ineffective, and should be modified or removed.

In another example, for a rule “a transaction with high transaction velocity should be forwarded for human review”, the user may notice that a vast majority of the transactions reviewed have a rule outcome disposition of “Rejected”. This may indicate to the user that the rule should be modified to read “a transaction with high transaction velocity should be rejected”, because transaction velocity in the example accurately predicts fraudulent transactions.

However, it should be noted that the rules, rule outcome frequencies, and rule outcome disposition frequencies given in the above examples are merely used for illustrative purposes and may not necessarily reflect real-world fraud patterns.

Embodiments of the invention provide the further advantage of providing profile outcome frequencies, profile outcome disposition frequencies, transaction outcome frequencies, and transaction outcome disposition frequencies to the user. This may allow the user to evaluate the combined performance of one or more rule profiles. For example, in an embodiment relating to fraud rules, this may allow the user to compare a profile outcome frequency value for “Rejected” to the corresponding profile outcome disposition frequency value for “Rejected”. If the frequency values are similar, that may indicate to the user that the profile is detecting most of the fraudulent transactions. However, if the profile outcome disposition frequency value for “Rejected” is much higher than the profile outcome frequency value for “Rejected”, that may indicate that most fraudulent transactions are not caught by the fraud rules. Similarly, the user may compare transaction outcome frequency values for a transaction outcome to the corresponding transaction outcome disposition frequency values to determine the effectiveness of the combination of all profiles. Without the aggregation and presentation of this information as in embodiments of the invention, making such determinations would be both inefficient and time-consuming.

Furthermore, embodiments of the invention provide advantage of enabling a user to request and manipulate transactions associated with a rule outcome. This provides the user with additional information regarding the transactions associated with a rule outcome, which the user may inspect to evaluate the effectiveness of the rule. For example, for a fraud rule “transactions with geo-location inconsistencies should be forwarded for human review”, the user may request the transactions triggering the fraud rule. The user may review the transactions, for example to determine which specific geo-locations are common among the transactions. This may enable the user to identify additional fraud trends and patterns, further increasing the effectiveness of the fraud detection system.

Embodiments of the invention provide the further advantage of providing a user with transaction details for a transaction. In some embodiments of the invention, the transaction details may include the profile in which a transaction was evaluated, any rules which were triggered by the transaction, and any rules which were not triggered by the transaction. This allows the user to manually inspect a single transaction and determine whether the fraud rules triggered by the transaction match the user's intuition. The user may use this information to determine the effectiveness of the fraud rules in analyzing the transaction. For example, if no fraud rules triggered for the transaction, and the transaction was fraudulent, this may indicate to the user that a new fraud rule should be defined to detect similar transactions. Thus, the transaction details may be used to improve the coverage of fraud rules.

The above examples highlight only a few of the advantages of using a multi-purpose device to provide membership and payment attributes.

### I. Exemplary Systems

Example embodiments are typically implemented in the context of a financial transaction. Therefore, prior to further discussing an audit log search capability within a fraud detection system, a brief description of transaction processing will be presented.

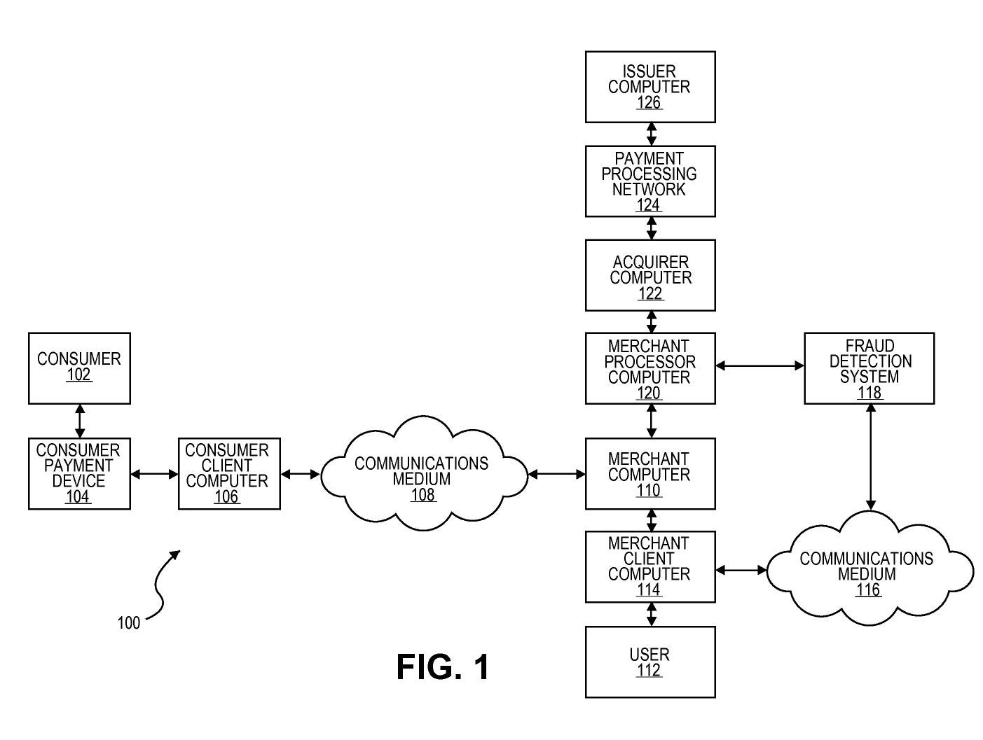

An exemplary system 100 for transaction processing can be seen in FIG. 1. The system 100 includes a consumer 102, a consumer payment device 104, a consumer client computer 106, a merchant computer 110, a user 112, a merchant client computer 114, a fraud detection system 118, a merchant processor computer 120, an acquirer computer 122, a payment processing network 124, and an issuer computer 126. In a typical transaction, a consumer 102 may purchase goods or services at a merchant associated with the merchant computer 110 using a consumer payment device 104. The transactions details are then sent to the merchant processor computer 120 and to the acquirer computer 122. The acquirer computer 122 can communicate with an issuer computer 126 via a payment processing network 124 for transaction processing. For simplicity of illustration, a certain number of components are shown is shown in FIG. 1. It is understood, however, that embodiments of the invention may include more than one of each component. In addition, some embodiments of the invention may include fewer than all of the components shown in FIG. 1. Also, the components in FIG. 1 may communicate via any suitable communication medium (including the internet), using any suitable communication protocol.

The consumer client computer 106 may communicate with the merchant computer 110 via a communications medium 108, such as a network (e.g. the Internet). Similarly, the merchant client computer 114 may communicate with the fraud detection system 118 via a communications medium 116, such as a network (e.g. the Internet).

The consumer 102 may be an individual, or an organization such as a business, that is capable of purchasing goods or services. The user 112 may be a merchant, an employee of the merchant, or any other individual who has access to the merchant client computer 114.

The consumer payment device 104 may be in any suitable form. For example, suitable consumer payment devices can be hand-held and compact so that it can fit into a consumer's wallet and/or pocket (e.g., pocket-sized). The consumer payment device 104 can include a processor, and memory, input devices, and output devices, operatively coupled to the processor. Specific examples of consumer payment devices include cellular or wireless phones, personal digital assistants (PDAs), pagers, portable computers, smart cards, and the like. The consumer payment devices can also be debit devices (e.g., a debit card), credit devices (e.g., a credit card), or stored value devices (e.g., a pre-paid or stored value card).

The consumer 102 can use the consumer client computer 106, which is communicatively coupled to the merchant computer 110 via the communications medium 108 in order to conduct a transaction with the merchant. The consumer client computer 106 may be in any suitable form. Example of consumer mobile devices include any device capable of accessing the Internet, such as a personal computer, cellular or wireless phones, personal digital assistants (PDAs), tablet PCs, and handheld specialized readers. The consumer client computer 106 transmits data through the communications medium 108 to the merchant computer 110. In some embodiments of the invention, the consumer payment device 106 and the consumer client computer 106 may be a single device.

In some embodiments of the invention, a merchant may use a merchant client computer 114 to communicate with fraud detection system 118. The merchant may use merchant client computer 114 to send search parameters to fraud detection system 18, receive and display fraud rules and rule profile reports generated by fraud detection system 118, and to request transactions from fraud detection system 118. In some embodiments, the merchant may also use merchant client computer 114 to approve, decline, or otherwise perform actions on transactions.

It should be noted that although some embodiments of the invention are described to comprise a fraud detection system 118, the invention is not so limited. For example, in some embodiments, any suitable rule evaluation system may take the place of fraud detection system 118.

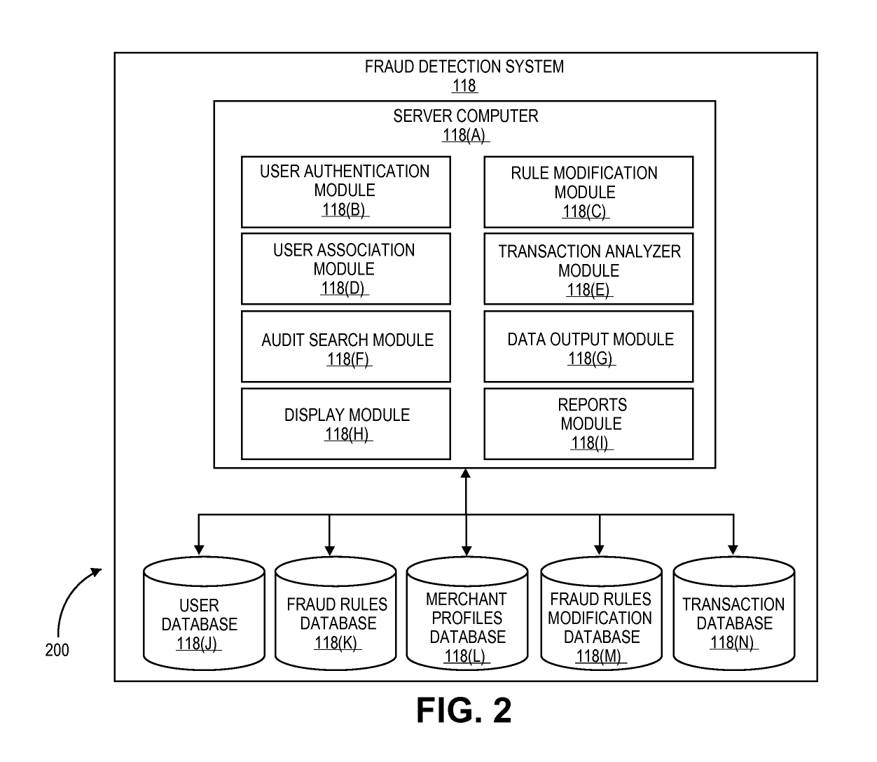

As depicted in FIG. 2, the fraud detection system 118 may comprise a server computer 118(A) comprising a user authentication module 118(B), a rule modification module 118(C), a user association module 118(D), a transaction analyzer module 118(E), an audit search module 118(F), a data output module 118(G), a display module 118(H), and a reports module 118(I). The various modules may be embodied by computer code, residing on computer readable media.

The server computer 118(A) may be operatively coupled to one or more databases. The one or more databases may comprise a user database 118(J), a fraud rules database 118(K), a rule profiles database 118(L) and a fraud rules modification database 118(M).

The user authentication module 118(B) handles the verification of the authorization credentials for a user (e.g. merchant ID, user name, password). The user authentication module 118(B) may access a user database 118(J) in determining whether a user seeking access to the fraud detection system 118 is an authorized user. For example, when presented with credentials, the user authentication module 118(B) may access the user database 118(J) to determine whether the provided user name is in the user database 118(J) and whether the provided password corresponds to the password linked to the user name.

The rule modification module 118(C) receives modifications from a user 112 to fraud detection rules or to a rule profile. The rule modification module 118(C) may further access the rule profiles database 118(L) to store modifications made to a rule profile. For example, when a user 112 makes a modification, the rule modification module 118(C) may access a rule profile database 118(L) associated with the authorization credentials entered by the user 112. The rule modification module 118(C) may also access the fraud rules database 118(K) to access pre-established fraud detection rules to add to the rule profile or to store newly created fraud detection rules created by the user for the rule profile. In some embodiments of the invention, new fraud detection rules created by the user are stored in the rule profiles database 118(L) with the corresponding rule profile.

The user association module 118(D) may associate any modifications made by a user 112 with the authorization credentials entered by the user. For example, if the user 112 logged into the fraud detection system 118 with the user name “user1,” the user association module 118(D) may record all the modifications made by the user 112, associate the modifications with the user name “user1,” and store the data in the fraud rules modification database 118(M).

The transaction analyzer module 118(E) may evaluate transaction data received by the fraud detection system 118 from the merchant processor computer 120. In embodiments of the invention, the fraud detection system 118 receives the authorization response message from the merchant processor computer 120 and the message is analyzed by the transaction analyzer module 118(E). If the result from the transaction analyzer module 118(E) is an “ACCEPT”, the transaction between the merchant and the consumer 102 can be completed. If the result from the transaction analyzer module 118(E) is a “REJECT”, the fraud detection system 118 would return a message to be presented to the consumer 102 that the consumer 102 may be contacted if there are any issues. For example, the consumer may receive a message stating, “Thank you for your order. We will contact you if there are any issues.” In embodiments of the invention, the message does not indicate that a “REJECT” was determined for the transaction as the consumer 102 may be attempting to conduct fraudulent transactions. If the result from the transaction analyzer module 118(E) is a “REVIEW”, the fraud detection system 118 would “hold” the transaction until it can be further reviewed, and it is determined whether it should be accepted or rejected. In some embodiments, the fraud detection system 118 can automatically invoke a settlement upon an accept decision by the transaction analyzer module 118(E).

The audit search module 118(F) handles the audit log search function of the fraud detection system 118. The audit search module 118(F) receives input from a user comprising search parameters to conduct an audit log search. The audit search module 118(F) processes the search parameters and conducts a search of the fraud rules modification database 118(L).

The data output module 118(G) outputs the results of the audit log search conducted by the audit search module 118(F) to be displayed to the user 112.

The display module 118(H) displays the layout of the fraud detection system 118. In embodiments of the invention, the fraud detection system 118 is accessed as a website over a communications medium, via an Internet-enabled device capable of displaying HTML.

The reports module 118(I) compiles the data obtained from the fraud detection system 118 from analyzing transactions. In embodiments of the invention, the reports module 118(I) can provide detailed statistics and data for the merchant on the performance of the merchant's profile and selection of fraud detection rules. For example, the reports module 118(I) can prepare a rule profile report comprising transaction outcome frequencies, transaction outcome disposition frequencies, profile outcome frequencies, profile outcome disposition frequencies, rule outcome frequencies, or rule outcome disposition frequencies. Reports module 118(I) can further indicate transaction outcomes and/or rule outcomes (e.g. accepted, rejected, or sent for further review). In embodiments of the invention, the reports model 118(I) can be queried to determine all transactions associated with a transaction outcome, profile outcome, rule outcome, or disposition. In embodiments of the invention, the reports module 118(I) can present the full transaction details for each transaction received by the fraud detection system 118.

The user database 118(J) may be used by the server computer 118(A) to store authentication elements for users. For example, the user database 118(J) may contain a plurality of merchant IDs and associated user names allowed to access the corresponding rule profile stored in the rule profiles database 118(L) in the fraud detection system.

The fraud rules database 118(K) may be used by the server computer 118(A) to store fraud detection rules that can be added to rule profiles. In embodiments, a rule profile can be loaded with pre-existing rules contained in the fraud rules database 118(K). The fraud rules database 118(K) may further store new rules created by a user 112. For each rule, fraud rules database 118(K) may also store possible rule outcomes and rule outcome dispositions. Fraud rules database 118(K) may also store statistics regarding each fraud rule, such as a fraud rule outcome frequency for each rule outcome, and a fraud rule outcome disposition frequency for each rule outcome disposition. In various embodiments, the fraud rules database 118(K) may store frequency values or frequency percentages. Fraud rules database 118(K) may also store transaction outcome frequencies.

The rule profiles database 118(L) may be used by the server computer 118(A) to store rule profiles that are customized for each merchant that has created a profile with the fraud detection system 118. The rule profile database 118(L) may further store fraud detection rules that have been created for a merchant and associated with a rule profile. In addition, the rule profile database 118(L) may also store rule profile outcomes, profile outcome frequencies, and profile outcome disposition frequencies.

The fraud rules modification database 118(M) may be used by the server computer 118(A) to store an audit log containing details regarding fraud detection rules, modifications made to the fraud detection rules, and the user name of the user who made the modifications to the fraud detection rules. The data stored in the fraud rules modification database 118(M) may be stored by the rule modification module 118(C) and may be searched by the audit search module 118(F).

The transaction database 118(N) may be used by the server computer 118(A) to store one or more transactions. The transactions may include transaction details such as a transaction identifier, consumer name, a consumer payment device identifier, a merchant name, an issuer, an acquirer, a transaction amount, a geo-location, or any other suitable transaction information. Additionally, transaction database 118(N) may include a rule profile identifier associated with each transaction, and the rule outcomes for each transaction generated by the rules in the rule profile. The transaction database may also comprise the transaction outcome and transaction disposition for the transaction.

The user 112 can use the merchant client computer 114, which is communicatively coupled to the fraud detection system 118 via the communications medium 108 in order to access the fraud detection system 118. The merchant client computer 114 may be in any suitable form. Example of merchant client computers include any device capable of accessing the Internet, such as a personal computer, cellular or wireless phones, personal digital assistants (PDAs), tablet PCs, and handheld specialized readers. The merchant client computer 114 transmits data through the communications medium 116 to the fraud detection system 118. In some embodiments of the invention, the merchant computer 110 and the merchant client computer 114 may be a single device.

The merchant computer 110 may be comprised of various modules that may be embodied by computer code, residing on computer readable media. It may include any suitable computational apparatus operated by a merchant. Examples of merchant computers may include an access device or an internet merchant computer. The merchant computer 110 may be in any suitable form. Additional examples of merchant client computers include any device capable of accessing the Internet, such as a personal computer, cellular or wireless phones, personal digital assistants (PDAs), tablet PCs, and handheld specialized readers. The merchant computer 110 transmits data through the communications medium 108 to the consumer client computer 106. The merchant computer 110 may also transmit data to a merchant processor computer 120. In embodiments of the invention, the merchant computer 110 receives transaction data from a consumer client computer 106 and transmits the transaction data to the merchant processor computer 120 for fraud evaluation and for further transaction authorization processes.

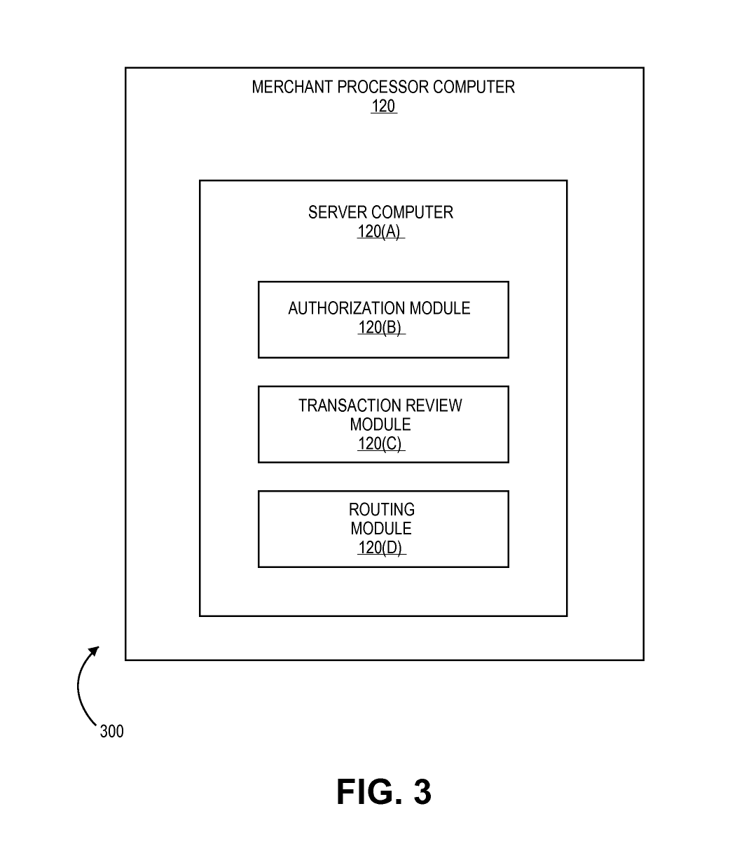

As depicted in FIG. 3, the merchant processor computer 120 may comprise a server computer 120(A) comprising an authorization module 120(B), a transaction review module 120(C), and a routing module 120(D). The various modules may be embodied by computer code, residing on computer readable media.

The authorization module 120(B) may generate and process authorization request and response messages. The authorization module 120(B) may also determine the appropriate destination for the authorization request and response messages. An authorization request message is a message sent requesting that an issuer authorize a financial transaction. An authorization request message may comply with ISO 8583, which is a standard for systems that exchange electronic transactions made by consumers using payment devices. An authorization request message according to other embodiments may comply with other suitable standards. In embodiments of the invention, an authorization request message may include, among other data, a Primary Account Number (PAN) and expiration date associated with a payment device (e.g. credit/debit card) of the consumer, amount of the transaction (which may be any type and form of a medium of exchange such a money or points), and identification of a merchant (e.g. merchant ID). In embodiments, an authorization request message is generated by a server computer (if the transaction is an e-commerce transaction) or a Point of Sale (POS) device (if the transaction is a brick and mortar type transaction) and is sent to an issuer via a payment processing network and an acquirer.

The transaction review module 120(C) conducts a fraud evaluation for transactions. If the transaction review module 120(C) determines that the transaction may be fraudulent, the transaction review module 120(C) may determine that the transaction should be denied. If the transaction review module 120(C) determines that the transaction is not fraudulent, the transaction review module 120(C) may determine that the transaction should be allowed. If the transaction review module 120(C) is unable to determine whether the transaction is fraudulent, the transaction review module 120(C) can send the transaction for further review.

The routing module 120(D) can route transactions to the appropriate destination. If a transaction is determined to be not fraudulent, the routing module 120(D) can route the message to the acquirer computer 122 for further processing. If the transaction is determined to be fraudulent, the routing module 120(D) can send the transaction back to the merchant. If the fraud evaluation conducted by the transaction review module 120(C) is indeterminate, the transaction can be routed to a further review by a person.

An acquirer computer 122 is typically a system for an entity (e.g. a bank) that has a business relationship with a particular merchant or other entity. An issuer computer 126 is typically a business entity (e.g. a bank) which maintains financial accounts for the consumer and often issues a consumer payment device 104 such as a credit or debit card to the consumer 102. Some entities can perform both issuer computer 126 and acquirer computer 122 functions. Embodiments of the invention encompass such single entity issuer-acquirers.

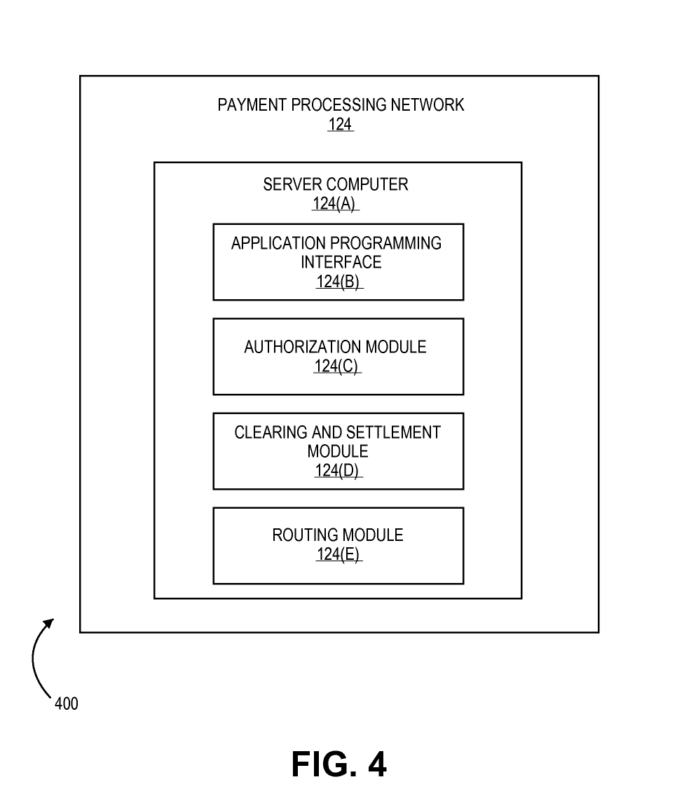

As depicted in FIG. 4, the payment processing network 124 may comprise a server computer 124(A) comprising an application programming interface 124(B), an authorization module 124(C), a clearing and settlement module 124(D), and a routing module 124(E). The various modules may be embodied by computer code, residing on computer readable media.

As noted above, the payment processing network 124 may have or operate at least a server computer 124(A). The server computer 124(A) may be coupled to the database and may include any hardware, software, other logic, or combination of the preceding for servicing the requests from one or more client computers. The server computer 124(A) may comprise one or more computational apparatuses and may use any of a variety of computing structures, arrangements, and compilations for servicing the requests from one or more client computers.

The payment processing network 124 may include data processing subsystems, networks, and operations used to support and deliver authorization services, exception file services, and clearing and settlement services. An exemplary payment processing network may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system which performs clearing and settlement services. The payment processing network 124 may use any suitable wired or wireless network, including the Internet.

The authorization module 124(C) processes authorization request messages and determines the appropriate destination for the authorization request messages. The clearing and settlement module 124(D) handles the clearing and settlement of transactions. These modules authenticate user information and organize the settlement process of user accounts between the acquirer computer 122 and the issuer computer 126. An example of the clearing and settlement module is Base II, which provides clearing, settlement, and other interchange-related services to VISA members.

The routing module 124(E) handles the routing of authorization request messages from the acquirer computer 122 to the issuer computer 126, and the routing the authorization response messages back from the issuer computer 126 to the acquirer computer 122.

### II. Exemplary Payment Methods

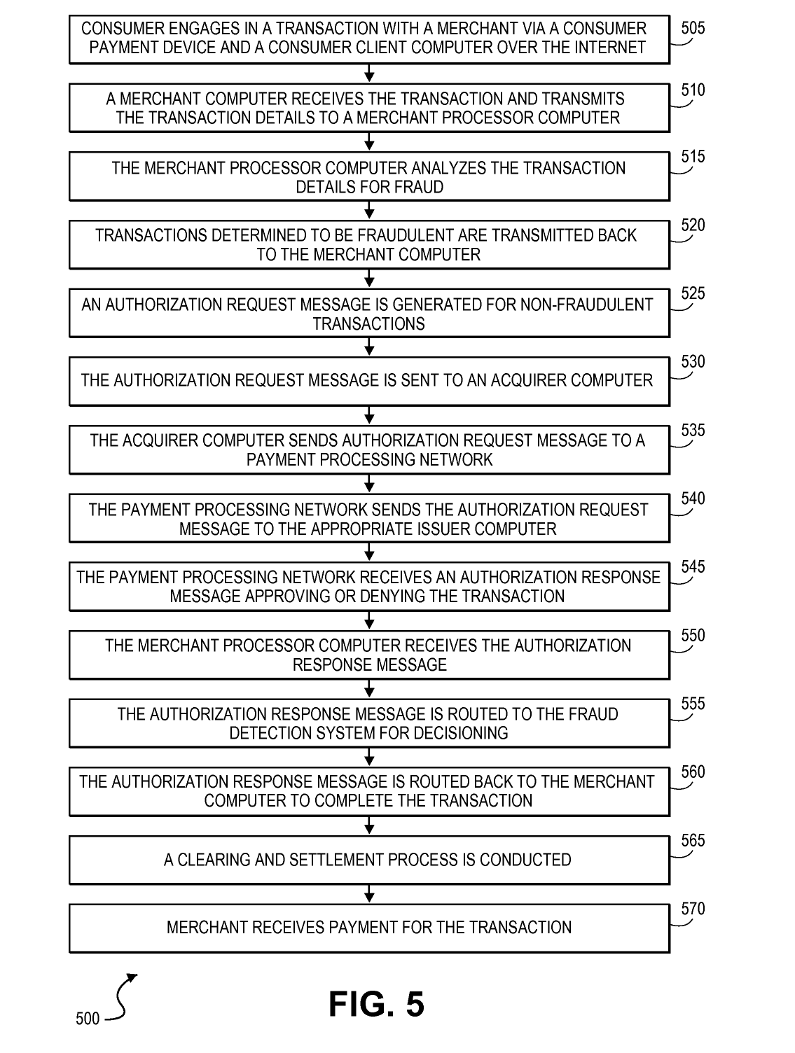

FIG. 5 shows a method 500 for processing a transaction through a system 100 shown in FIG. 1.

In step 505, in a typical transaction, the consumer 102 engages in a transaction for goods or services at a merchant associated with a merchant computer 110 using a consumer client compute 106 and a consumer payment device 104 such as a credit card or mobile phone. For example, the consumer 102 may use their Internet-enabled phone to access a merchant website to conduct a transaction using their consumer payment device 104. In other embodiments, the consumer 102 may swipe the credit card through a POS terminal or, in another embodiment, may take a wireless phone and may pass it near a contactless reader in a POS terminal.

In step 510, the merchant computer 110 receives the transaction from the consumer client computer 106 and may then transmit the transaction details to the merchant processor computer 120. Transactions details may be comprised of, but is not limited to, the following: consumer name, consumer billing address, consumer shipping address, consumer phone number, consumer account number, items purchased, price, etc.

In step 515, the merchant processor computer 120 may conduct a fraud analysis and determine whether the transaction should proceed or whether it should be rejected and returned to the merchant computer 110. The merchant processor computer 120 may use the transaction details in determining whether the transaction may be fraudulent.

In step 520, if the merchant processor computer 120 determines that the transaction details indicate that the transaction may be fraudulent, the merchant processor computer 120 may return the transaction to the merchant computer 110 indicating that the transaction is fraudulent and should be declined.

In step 525, if the merchant processor computer 120 determines that the transaction details indicate that the transaction is not fraudulent, an authorization request message may then be generated. The authorization request message may be generated in any suitable format.

An “authorization request message” may include an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction. The authorization request message may also include other information such as information that identifies the access device that generated the authorization request message, information about the location of the access device, etc.

In step 530, the generated authorization request message may be transmitted by the merchant processor computer 120 to an acquirer computer 122. The authorization request message may be transmitted in any suitable format.

In step 535, after receiving the authorization request message, the authorization request message may then be transmitted to a payment processing network 124.

In step 540, after receiving the authorization request message, the payment processing network 124 may then transmit the authorization request message to an appropriate issuer computer 126 associated with the consumer payment device 104.

In step 545, the issuer computer 126 receives the authorization request message. The issuer computer 126 may then determine whether the transaction should be authorized. The issuer computer 126 transmits an authorization response message back to and received by the payment processing network 124 to indicate whether or not the current transaction is accepted or rejected.

An “authorization response message” may include an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

In step 550, the payment processing network 124 may then forward the authorization response message back to the acquirer computer 122. The acquirer computer 122 may then send the response message back to the merchant processor computer 120.

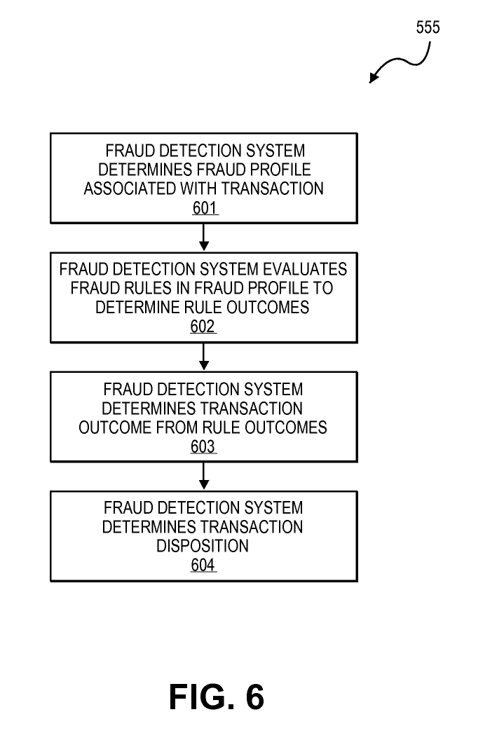

In step 555, the merchant processor computer 120 may then send the authorization response message to a fraud detection system 118. The fraud detection system 118 may then undertake a decision process based on the authorization response message. In some embodiments of the invention, the decision process may comprise the method shown in FIG. 6.

FIG. 6 shows a fraud detection system decision process for evaluating fraud rules to determine a transaction outcome for a transaction.

At step 601, the fraud detection system 118 determines a fraud rule profile associated with the transaction. The determination may be made using information stored in the authorization response message, transaction details sent by merchant computer 110, the merchant at which the transaction took place, or any other suitable criteria.

At step 602, once fraud detection system 118 determines a rule profile associated with the transaction, the fraud detection system evaluates the rules in the rule profile. In some embodiments, the rules may comprise a condition and a rule outcome. The condition may describe the circumstances under which the outcome is determined for the rule. In one example, the condition may be “the transaction has a transaction amount greater than $500 and a high transaction velocity”. An outcome may be “Rejected”, to indicate that such transactions should be rejected by fraud detection system 118. A rule profile may have one or more rules. Each rule in the rule profile is evaluated to determine a rule outcome, if any, for the transaction.

In some embodiments, if a rule outcome is determined, fraud detection system 118 may store the rule outcome in fraud rules database 118(K) or transaction database 118(N). Additionally, fraud detection system 118 may calculate or update a rule outcome frequency for the rule outcome and store it in fraud rules database 118(K). In one example, a transaction may be determined to have a rule outcome of “Rejected” for an evaluated rule. Accordingly, fraud detection system 118 may increment by one the rule outcome disposition value for “Rejected” for the evaluated rule.

At step 603, fraud detection system 118 determines a transaction outcome from the determined rule outcomes. Typically, the transaction outcome may be determined using a pre-defined precedence relationship between the rule outcomes. For example, in one embodiment, if no rule outcomes are determined, or all determined rule outcomes are “Accepted”, then a transaction outcome may be “Accepted” by default. If at least one of the rule outcomes is “Rejected”, then the transaction outcome may be “Rejected, regardless of how many “Accepted” rule outcomes determined. However, if at least one of the rule outcomes is “Force Accepted”, then the rule outcome may be “Force Accepted” regardless of how many “Rejected” or “Accepted” rule outcomes determined. Other embodiments of the invention may use other methodologies for determining a transaction outcome using rule outcomes. In some embodiments, the transaction outcome is stored in transaction database 118(N).

At step 604, fraud detection system 118 determines the transaction disposition for each transaction. In some embodiments, the transaction disposition may be determined significantly after the transaction occurs (e.g., 90 days after). This may allow time for a consumer 102 to inspect their statement, identify possibly fraudulent transactions, and contact their issuer associated with consumer payment device 104. In some embodiments, the transaction

Once the transaction disposition is determined, the fraud detection system 118 may calculate or update a rule outcome disposition frequency for each rule that was triggered when the fraud rules were evaluated. In one example, a transaction may be determined to have a disposition of “Rejected” after consumer 102 identifies the transaction as fraudulent to the issuer. Accordingly, fraud detection system 118 may increment by one the rule outcome disposition frequency value for “Rejected” for each rule evaluated.

Returning to FIG. 5, step 555, if the result from the fraud detection system 118 is “Accepted”, the transaction between the merchant and the consumer 102 can be completed (e.g., the authorization status can be approved). If the result from the fraud detection system 118 is “Rejected”, the fraud detection system 118 would return a message to be presented to the consumer 102 that the consumer 102 may be contacted if there are any issues (e.g., the authorization status would be declined). For example, the consumer 102 may receive a message stating, “Thank you for your order. We will contact you if there are any issues.” In embodiments of the invention, the message does not indicate that “Rejected” was determined for the transaction as the consumer 102 may be attempting to conduct fraudulent transactions. If the result from the fraud detection system 118 is a “Review”, the fraud detection system 118 may “hold” or delay assigning the authorization status of the transaction until it can be further reviewed to determine whether it should be accepted or rejected.

In step 560, after the merchant computer 110 receives the authorization response message, the merchant computer 110 may then provide the authorization response message to the consumer 102. For example, the consumer may be presented with a screen on the consumer client computer 106 indicating success or failure of authorization. In other embodiments, the authorization response message may be displayed by the POS terminal, or may be printed out on a receipt.

In step 565, at the end of the day or at a period determined by the merchant, a normal clearing and settlement process can be conducted. A clearing and settlement process may include a process of reconciling a transaction. A clearing process is a process of exchanging financial details between an acquirer computer 122 and an issuer computer 126 to facilitate posting to a party's account and reconciliation of the party's settlement position. Settlement involves the delivery of securities from one party to another. In some embodiments, clearing and settlement can occur simultaneously.

In step 570, the merchant receives payment for the transaction.

### III. Exemplary Rule Profile Report Methods

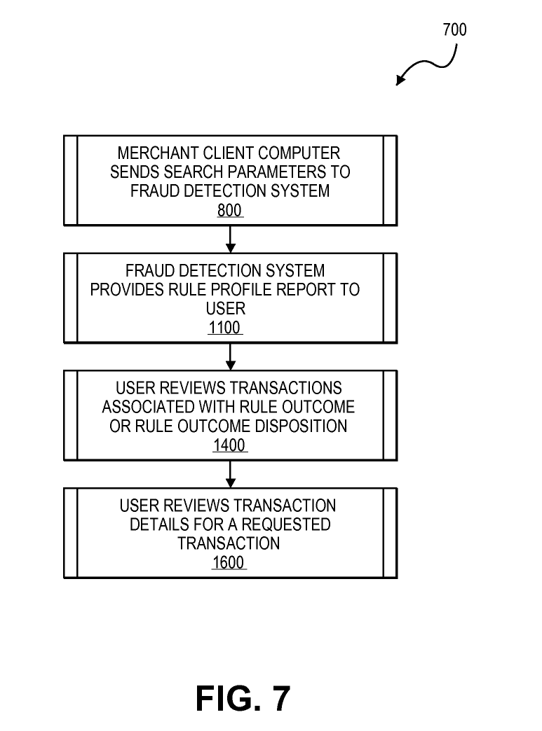

FIG. 7 shows a method 700 to request, display, and use a rule profile report. In some embodiments, method 700 may be initiated by a user 112 associated with a merchant. For example, the user 112 may be a merchant employee responsible for defining and monitoring fraud rules. User 112 may initiate the method when, for example, the user 112 desires information regarding the performance of the previously defined fraud rules. User 112 may operate merchant client computer 114 or any other suitable device to initiate method 700.

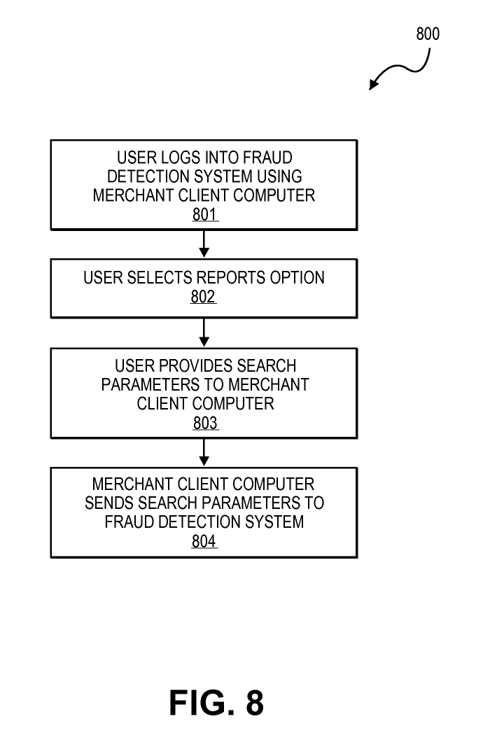

At process 800, merchant client computer 114 sends search parameters to fraud detection system 118. The search parameters may include information used to determine one or more transactions for which the fraud rule profile should be generated. In some embodiments, search parameters may include a date range, a transaction amount, an issuer, or any other suitable attribute of a transaction. For example, a search parameter may be to retrieve transactions which occurred in the previous 24 hours. In some embodiments, search parameters may also include the identity of a merchant. For example, user 112 associated with a merchant may log in to fraud detection system 118. A search parameter may be to retrieve transactions associated with the merchant associated with user 112. In some embodiments, the method illustrated in FIG. 8 may be used to implement process 800.

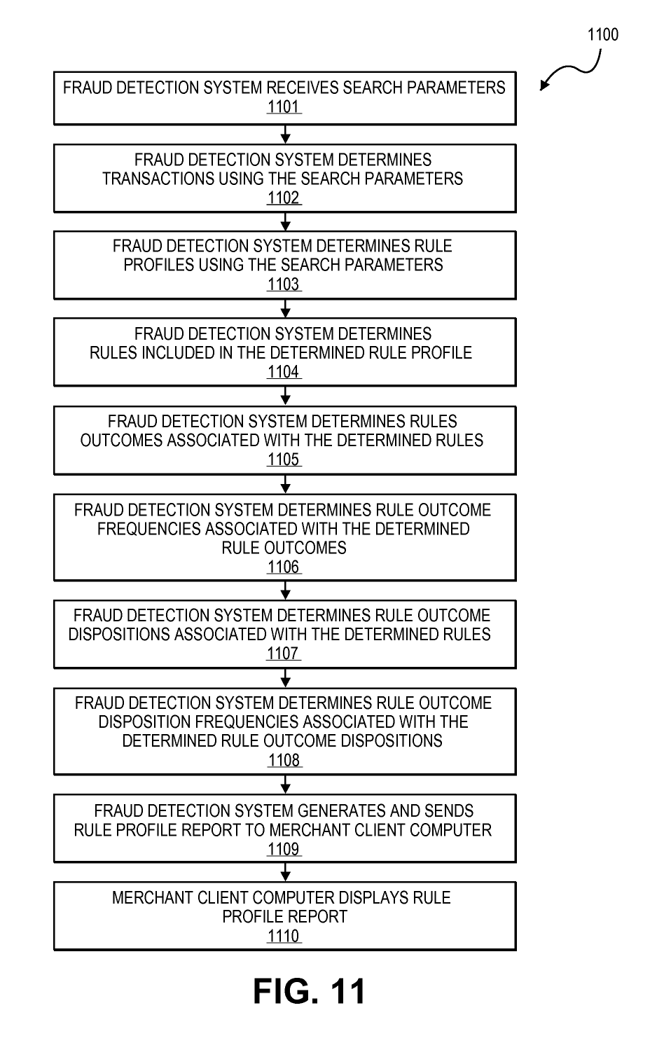

At process 1100, fraud detection system 118 provides a rule profile report to user 112. Typically, the rule profile report may be generated based on the search parameters sent to fraud detection system 118. In some embodiments, the rule profile report may comprise one or more rule profiles. Each rule profile may comprise a plurality of rules. Each rule may comprise a plurality of rule outcome frequencies and rule outcome disposition frequencies. Fraud detection system 118 may represent the rule outcome frequencies and rule outcome disposition frequencies as values, percentages, or any other suitable means. In some embodiments, the method illustrated in FIG. 11 may be used to implement process 1100.

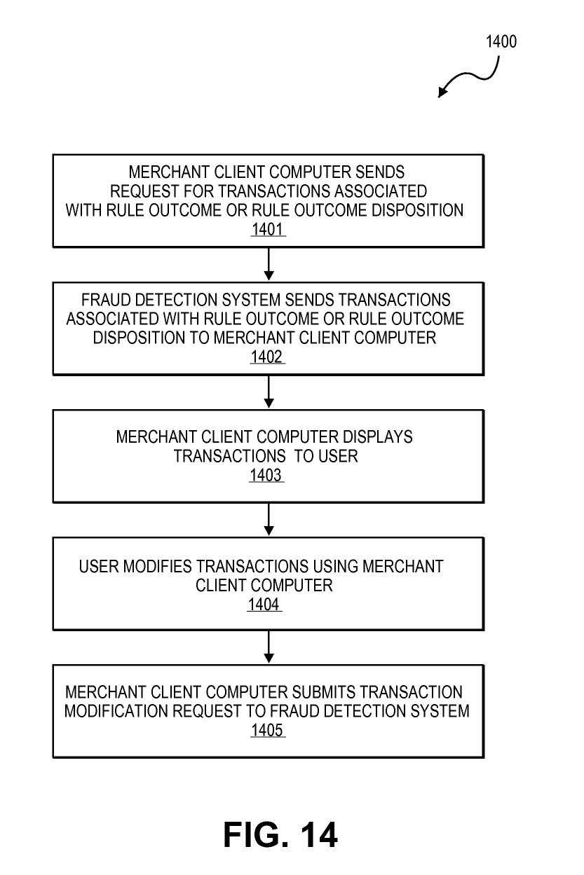

At process 1400, user 112 reviews transactions associated with a rule outcome or rule outcome disposition. In some embodiments of the invention, the transactions may be included in the rule profile report. In other embodiments, user 112 may request the transactions associated with a rule outcome or rule outcome disposition from fraud detection system 118 using merchant client computer 114. Merchant client computer 114 may display the transactions to user 112 in any suitable format, such as a list, table, or chart. In some embodiments, the review may comprise user 112 modifying one or more transactions. For example, user 112 may manually accept or decline a transaction, overriding the transaction outcome determined by fraud detection system 112 in step 603 of the method described in FIG. 6. In some embodiments, the method illustrated in FIG. 14 may be used to implement process 1400.

At process 1600, user 112 reviews transaction details associated with a transaction. In some embodiments of the invention, the transaction may be selected from transactions associated with a rule outcome or rule outcome disposition and sent by fraud detection system 118 in process 1400. In other embodiments, the transaction may be selected from a list of all transactions associated with a rule profile report. The transaction details may comprise various information regarding the transaction, such as a transaction date, a transaction identifier, consumer data, merchant data, and payment data. The transaction details may be displayed in any suitable format, such as a list format, table format, or other graphical format.

FIG. 8 shows a method for a user 112 to send search parameters to fraud detection system 118 using merchant client computer 114. The method illustrated in FIG. 8 may be performed by user 112 in order to request a rule profile report associated with the sent search parameters.

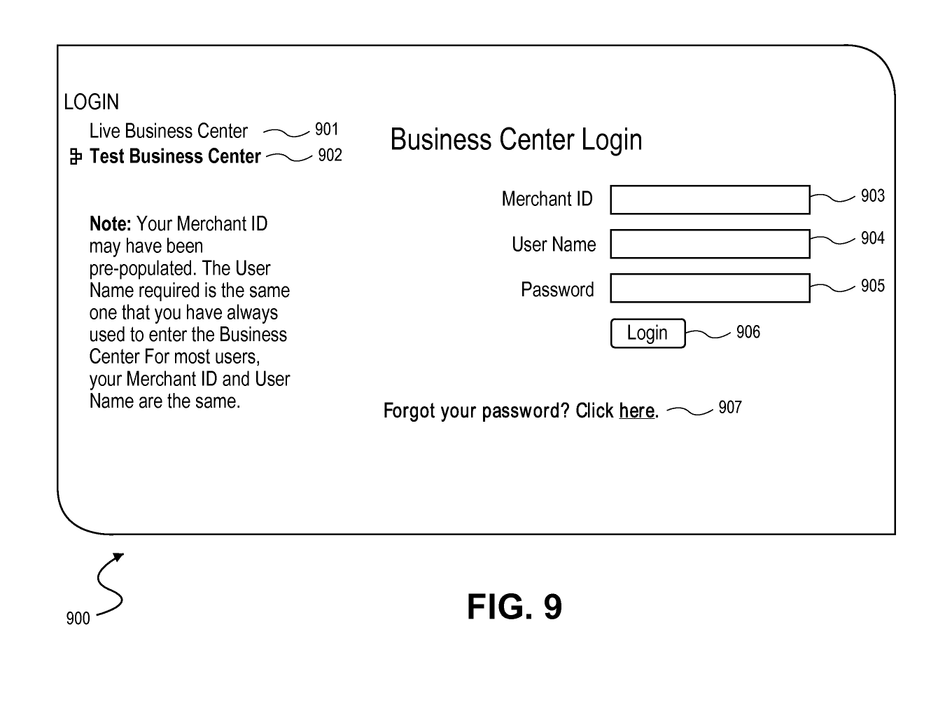

At step 801, user 112 logs into fraud detection system 118 using merchant client computer 114. User 112 may log into fraud detection system 118 using any suitable means. For example, in some embodiments of the invention, the user may present account credentials using a web page or software application. If account credentials submitted by user 112 correspond to account credentials stored in user database 118(J), fraud detection system 118 may log user 112 into the system. In one embodiment, the user interface shown in FIG. 9 may be used as a login interface.

FIG. 9 shows an exemplary user interface 900 for logging into fraud detection system 118 in accordance with some embodiments of the invention. In some embodiments, fraud detection system 118 may be divided into multiple business centers, each relating to a deployment of fraud rules. In the shown interface, user 112 may select a business center to log into. For example, user 112 may select live business center 901 in order to log into a production deployment. In some embodiments, the production deployment may process actual consumer transactions and actively influence the transaction outcome of the transactions processed. In addition, user 112 may select test business center 902 in order to log into a testing deployment. In some embodiments, the testing deployment may operate on historical, automatically generated, or sample transactions. In other embodiments, the testing deployment may operate on consumer transactions, but determine non-binding transaction outcomes. In various embodiments, user 112 may select other business centers in order to log into other deployments.

User 112 may enter account credentials in merchant ID field 903, user name field 904, and password field 905 in order to access fraud detection system 118. User 112 may enter a merchant ID into merchant ID field 903. A merchant ID may be any identifier associated with a merchant. For example, in some embodiments, a merchant ID may be a merchant account number associated with payment processing network 124 or fraud detection system 118. User name 112 may also enter may be any suitable username or other user identifier into user name field 904. User 112 may further enter any suitable password, PIN, or other secret identifier into password field 905. User 112 may initiate a login by selecting login button 906, so that merchant client computer 114 establishes a secure trusted connection with fraud detection system 118. Alternately, if user 112 has forgotten his or her password, user 112 may click forgotten password link 907.

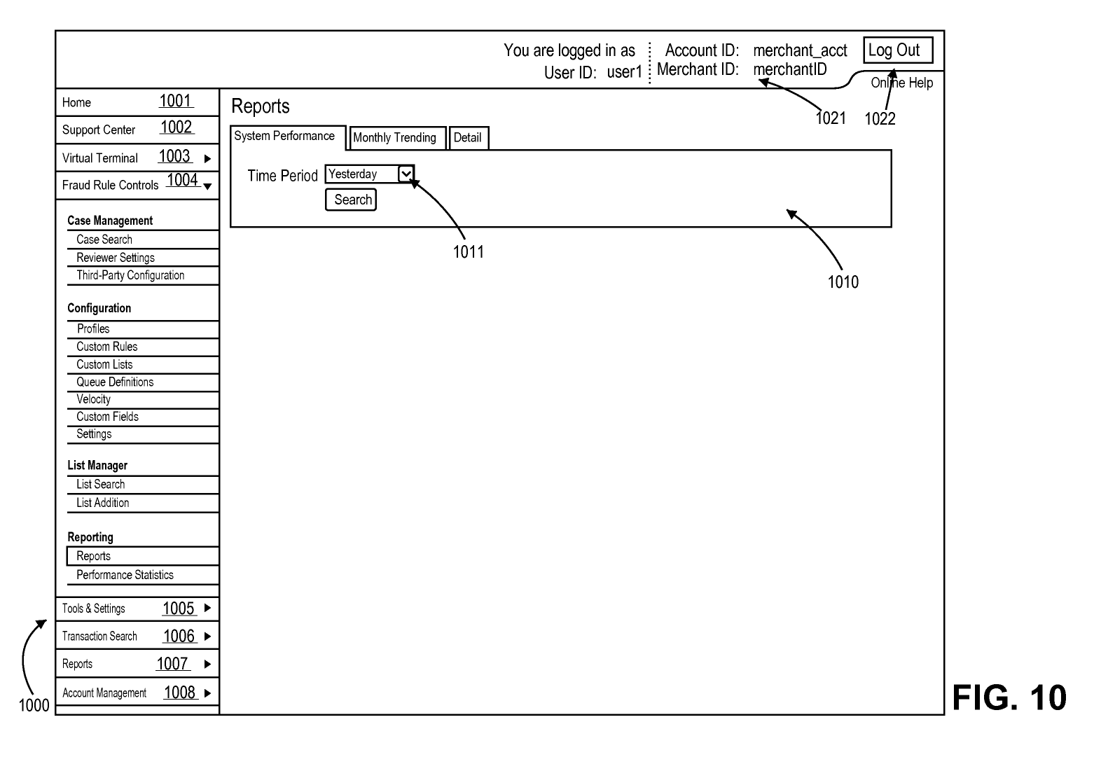

Returning to FIG. 8, at step 802, user 112 selects a reports option. Typically, the reports option may be included in a web page or other interface sent by fraud detection system 118 to merchant client computer 114. In one embodiment, the reports home page shown in FIG. 10 may be used by user 112 to select the reports option.

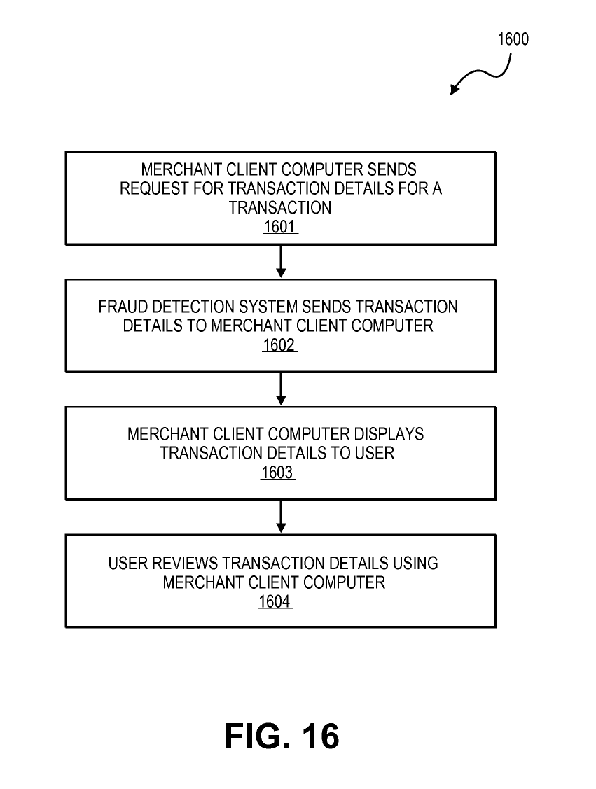

FIG. 10 shows a reports home page 1000 for selecting a reports option and accepting search parameters from user 112. In some embodiments, the user interface 1000 may be generated as a web page by fraud detection system 118 and displayed by merchant client computer 114. The left-column menu includes a selection of options for using the fraud detection system 118. Selecting the “Home” 1001 option may take the user 112 to the home screen of the fraud detection system 118. Selecting the “Support Center” 1002 option may take the user 112 to the Help and Support Center for the fraud detection system 118. Selecting the “Virtual Terminal” 1003 option may take the user 112 to a page that the user 112 can use to simulate transactions to test the fraud detection system 118. Selecting the “Fraud Rule Controls” 1004 option may take the user 112 to the fraud detection rules and merchant profile settings and controls, as well as reports, performance statistics, and other options shown in FIG. 10. There the user can add, modify, or delete, fraud detection rules and/or merchant profiles. Selecting the “Tools & Settings” 1005 option may take the user 112 to a variety of tools that the user 112 can use with the fraud detection system 118. Selecting the “Transaction Search” 1006 option may take the user 112 to a search page that the user 112 can utilize to conduct searches for specific transactions. In some embodiments, the searches may be conducted in accordance with the methods described in FIGS. 14 and 16. Selecting the “Reports” 1007 option may take the user 112 to a Reports page that allows the user 112 to review different activity compiled by the fraud detection system 118 in specialized and customizable reports. Selecting the “Account Management” 1008 option may take the user 112 to a variety of administrative functions including the “Audit Search” function. In embodiments of the invention, a user 112 can access the Reports home page 1000 by selecting “Reports” option from the Fraud Rule Controls 1004 menu.

Additional information and options displayed on the reports home page 1000 include the login information section 1021 containing the user ID, account ID, and merchant ID. The user 112 can log out of the fraud detection system 118 by selecting the “Log Out” option 1022.

Returning top FIG. 8, at step 803, user 112 provides search parameters to merchant client computer 114. User 112 may provide the search parameters to the merchant using any suitable means. In one embodiment, the reports home page shown in FIG. 10 may be used by user 112 to provide search parameters.

In the embodiment shown in FIG. 10, once the user 112 is presented with the Reports home page, the user 112 can select from a plurality of search parameters. The user 112 can access a report showing system performance by selecting the “System Performance” tab 1010 and selecting the period for a System Performance report. In embodiments of the invention, the user 112 can optionally select to review the system performance for the previous day, the week to date, the previous week, the month to date, the previous month, or over a custom date range. Selecting the custom date range causes a custom date range window pop-up to appear. The user 112 can then set a start and end date for the user's 112 desired search. In other embodiments of the invention, the user 112 can be presented with additional search parameters and options. In the shown example, user 112 provides search parameter 1011 “Yesterday” using the appropriate search parameter dropdown listbox, indicating that transactions occurring the previous day may be used to generate the rule profile report.

At step 804, merchant client computer 114 transmits the search parameters over a communications medium 116 to fraud detection system 118 in order to generate the requested rule profile report. The search parameters are received by the fraud detection system 118 over the communications medium 116. As shown in FIG. 10, once the user 112 has selected the search parameters for their search, the user 112 selects the “Search” button in the “System Performance” tab 810 in order to conduct the search.

FIG. 11 shows a method of generating a rule profile report using fraud detection system 118 and providing the report to user 112.

At step 1101, fraud detection system 118 receives search parameters. In some embodiments, the rule profile report may be generated after receiving search parameters selected by user 112 from merchant client computer 114. In some embodiments, the search parameters may be transmitted to fraud detection system using Ajax, an HTTP POST or GET message, a socket transmission, or in any other suitable format.

At step 1102, fraud detection system 118 determines a plurality of transactions using the search parameters. In some embodiments, the search parameters may indicate one or more transaction criteria. Fraud detection system 118 may query transaction database 118(N) for transactions satisfying the transaction criteria. For example, user 112 may specify a search parameter for transactions occurring the previous day. Fraud detection system 118 may then determine, using transaction database 118(N), which transactions occurred in the previous day. Using the determined transactions, fraud detection system 118 may determine a transaction total, transaction outcome frequencies, and transaction outcome disposition frequencies for the rule profile report.

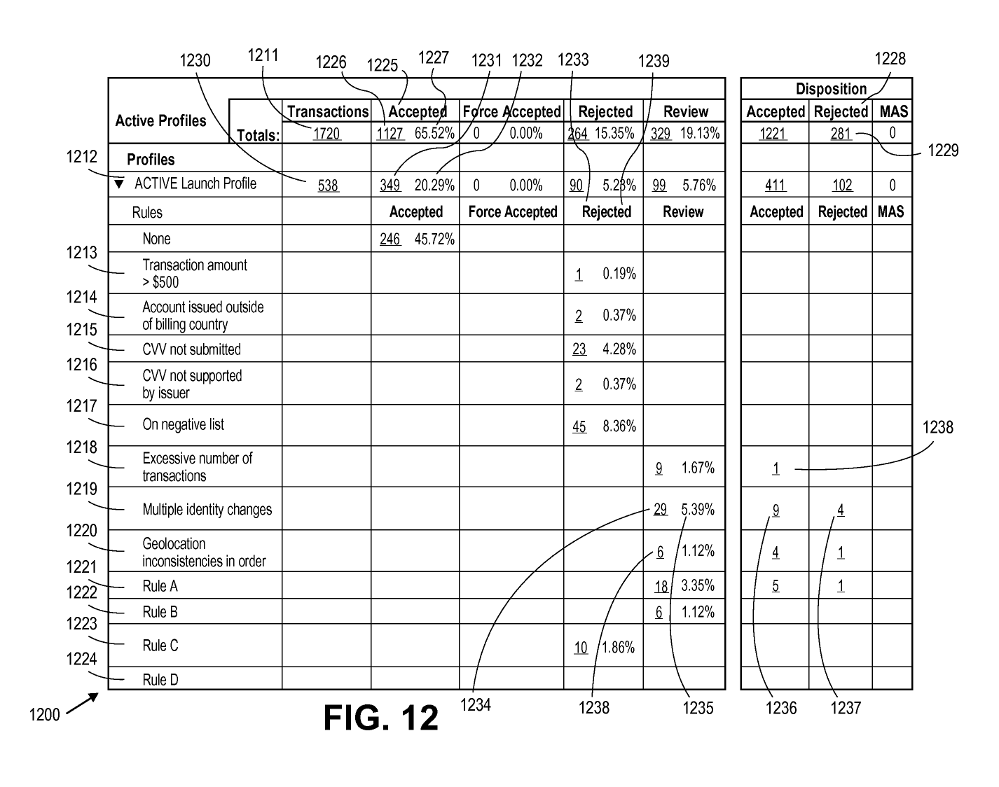

FIG. 12 illustrates an exemplary rule profile report 1200 generated by fraud detection system 118 using search parameters specified by user 112 according to one embodiment of the invention. In FIG. 12, user 112 specifies a search parameter for transactions occurring the previous day. Accordingly, fraud detection system 118 determines the number of transactions occurring yesterday to be 1720, as reflected by transaction total 1211. Fraud detection system 118 also determines transaction outcomes for the determined transactions. In the shown example, accepted transaction outcome 1225 is one possible transaction outcome. Accepted transaction outcome 1225 has a corresponding accepted transaction outcome frequency value 1231 of 1127, indicating that 1127 of the 1720 transactions conducted yesterday were accepted by fraud detection system 118. Analogously, accepted transaction outcome frequency percentage 1227 is 65.52%, reflecting the percentage of the transaction total that corresponds to accepted transaction (i.e., 1127/1720=65.52%). Rule profile report 1200 similarly includes transaction outcomes, transaction outcome frequency values, and transaction outcome frequency percentages for transactions with “Force Accepted”, “Rejected”, and “Review” transaction outcomes. In the shown example, the sum of all transaction outcome frequency values is equal to the transaction total 1211.

Rule profile report 1200 may also display transaction outcome dispositions and transaction outcome disposition frequencies. For example, rejected transaction outcome disposition 1228 has a corresponding rejected transaction outcome disposition frequency value 1229 of 281, indicating that 281 of 1720 transactions conducted yesterday had a transaction disposition of “Rejected”. Rule profile report 1200 similarly includes transaction outcome dispositions and transaction outcome disposition frequencies for transactions with a disposition of “Accepted” and a disposition of “MAS”. In some embodiments of the invention, a transaction outcome disposition of “MAS” may indicate that the transaction should be “marked as suspect”. In some embodiments, not all transactions may have a transaction outcome disposition. For example, transactions which have not been confirmed as fraudulent or paid for by the consumer may not be assigned a transaction outcome disposition.

Returning to FIG. 11, at step 1103, fraud detection system 118 determines rule profiles using the search parameters. In some embodiments, the rule profiles may be queried from rule profiles database 118(L). In some embodiments, the search parameters may specifically indicate one or more rule profiles. For example, the search parameters may comprise a list of profiles selected by user 112. In some embodiments, rule profiles may also be determined using the transactions determined in step 1102. For example, at step 1102, fraud detection system 118 may determine transactions occurring in the previous day. At step 1103, fraud detection system 118 may then determine rule profiles associated with the determined transactions. For each profile, fraud detection system 118 may determine a profile transaction total and profile outcome frequencies.

In the example rule profile report shown in FIG. 12, a single rule profile is determined: ACTIVE Launch Profile fraud rule profile 1212. ACTIVE Launch Profile 1212 has a profile transaction total 1230 of 538, indicating that 538 of the 1720 transactions represented by rule profile report 1200 are associated with the ACTIVE Launch Profile. In addition, rule profile report 1200 may indicate profile outcome frequencies for each profile outcome. For example, accepted profile outcome frequency value 1231 is 349, indicating that 349 of the 538 transactions associated with the ACTIVE Launch Profile had a transaction outcome of accepted by fraud detection system 118. Analogously, accepted profile outcome frequency percentage 1232 is 20.29%, because 349 is 20.29% of 538. Rule profile report 1200 similarly shows other profile outcomes, profile outcome frequencies, profile outcome dispositions, and profile outcome disposition frequencies for ACTIVE Launch Profile 1212.

At step 1104, fraud detection system 118 determines one or more rules included in the determined rule profiles. In some embodiments, a mapping of rule profiles to rules may be included in rule profile database 118(L). Alternately, in some embodiments, the rules may be determined using fraud rules database 118(K).

In rule profile report 1200, ACTIVE Launch Profile 1212 includes several fraud rules 1213-1224. For example, transaction amount rule 1213 indicates that transactions with an amount greater than $500 should have a rule outcome of “Rejected”. CVV not submitted rule 1215 indicates that transactions without a CVV submitted should also have a rule outcome of “Rejected”. Excessive transactions rule 1218 indicates that transactions with an excessive transaction velocity should have a rule outcome of “Review”. Similarly, other rules may indicate rule outcomes based on other conditions.

At step 1105, fraud detection system 118 determines rule outcomes associated with the determined rules. In some embodiments, a list of rule outcomes associated with the determined rules may be stored in fraud rules database 118(K). In other embodiments, such as embodiments where rule outcomes are shared for all rules in a rule profile, rule outcomes may be determined using rule profiles database 118(L).

In rule profile report 1200, transactions may have the rule outcomes: “Accepted”, “Force Accepted”, “Rejected”, and “Review”. Each rule outcome is associated in a column in report 1200. For example, rejected rule outcome 1233 is associated in a column with transactions having the authorization status 1239 of “Rejected” per the appropriate rules. Rejected rule outcome 1233 is used to show rule outcome frequencies corresponding to a rule outcome of “Rejected”.

At step 1106, fraud detection system 118 determines rule outcome frequencies associated with the determined rules. In some embodiments, the rule outcome frequencies may be retrieved from fraud rules database 118(K). In such embodiments, the rule outcome frequencies may have been calculated and updated as each rule outcome was determined. In other embodiments, the rule outcome frequencies may be determined dynamically for the transactions determined at step 1102. In some such embodiments, rule outcome frequencies may be determined by determining the number of transactions associated with each rule outcome. The determined number may be the rule outcome frequency value. The determined number divided by the profile transaction total may be the rule outcome frequency percentage. In some embodiments, the sum of all rule outcome frequency values may not equal the corresponding profile outcome frequency value; this may be because multiple rules can be triggered for a single transaction.

For example, as shown in rule profile report 1200, fraud detection system 118 may determine a rule outcome frequency value of 29 for the rule outcome “Review” for rule 1219. This may indicate that multiple identity changes rule 1219 was triggered 29 times out of the 538 transactions associated with ACTIVE Launch Profile 1211. Accordingly, the rule outcome frequency percentage 1235 for rule 1219 is 29/538=5.39%.

At step 1107, fraud detection system 118 determines rule outcome dispositions associated with the determined rules. In some embodiments, a list of rule outcome dispositions associated with the determined rules may be stored in fraud rules database 118(K). In other embodiments, such as embodiments where rule outcomes are shared for all rules in a rule profile, rule outcomes may be determined using rule profiles database 118(L).

In rule profile report 1200, transactions may have the rule outcome dispositions: “Accepted”, “Rejected”, and “MAS”. Each rule outcome disposition is associated in a column in report 1200. For example, rejected rule outcome disposition 1238 is used to show rule outcome disposition frequencies corresponding to a rule outcome disposition of “Rejected”.

At step 1108, fraud detection system 118 determines rule outcome disposition frequencies associated with the determined rules. In some embodiments, the rule outcome disposition frequencies may be retrieved from fraud rules database 118(K). In such embodiments, the rule outcome disposition frequencies may have been calculated and updated as each rule outcome disposition was determined. In other embodiments, the rule outcome disposition frequencies may be determined dynamically for the transactions determined at step 1102, for example by using transaction database 118(L). In some embodiments, rule outcome disposition frequencies may be calculated in a similar manner to rule outcome frequencies.

For example, as shown in rule profile report 1200, fraud detection system 118 may determine an accepted rule outcome disposition frequency value 1236 of 9 for rule 1219. This may indicate that of the 29 transactions in which multiple identity changes rule 1219 was triggered, 9 of the transactions had a rule outcome disposition of “Accepted” (e.g., a customer confirmed the charges as intentional). Similarly, fraud detection system 118 may determine a rejected rule outcome disposition frequency value 1237 of 4, indicating that 4 of the 29 transactions had a rule outcome disposition of “Rejected” (e.g., a customer confirmed the charges as fraudulent).

At step 1109, fraud detection system 118 generates and sends a rule profile report to merchant client computer 114. Typically, the rule profile report may comprise a transaction total, one or more transaction outcome frequencies, transaction outcome disposition frequencies, rule profiles, profile transaction totals, profile outcome frequencies, profile outcome disposition frequencies, rules, rule outcome frequencies, and rule outcome disposition frequencies. In various embodiments, the rule profile report sent to merchant client computer 114 may be a transmitted as a web page, table, image, document, or in any other suitable format.

At step 1110, merchant client computer 114 displays the rule profile report. In some embodiments, the rule profile report may be displayed in tabular format, for example in the format shown in rule profile report 1200. In other embodiments, rule profile report may be displayed in a graphical format, a list format, or any other suitable format. In some embodiments, the rule profile report may be interactive. Outcome frequency values and disposition frequency values may be clicked to request all transactions associated with the corresponding outcome or disposition. For example, as shown in rule profile report 1200, rule outcome frequency values may be clicked to request all transactions associated with the corresponding rule outcome.

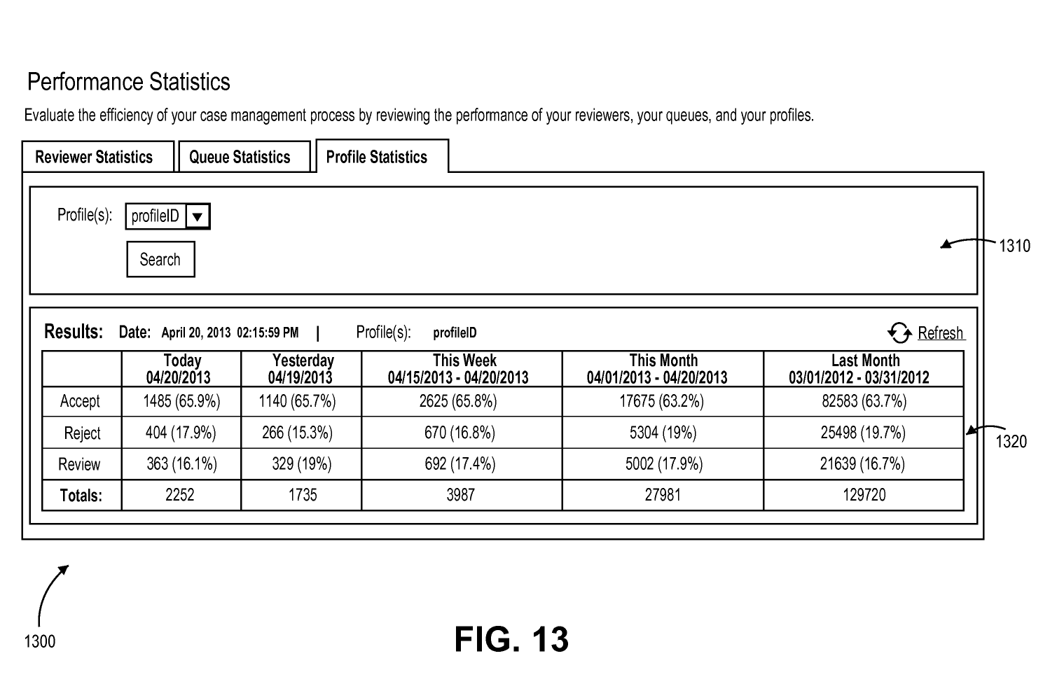

In some embodiments, the rule profile report may be shown in an aggregated or summarized format. For example, FIG. 13 depicts an exemplary summarized rule profile report 1300. In embodiments of the invention, the summarized rule profile report 1300 can provide the user 112 with detailed statistics of the efficiency of one or more rule profiles. In some embodiments, user 112 can select which profile to view statistics for by using the drop-box in a profile selection box 1310. The search results are displayed in a search results box 1320. In embodiments of the invention, the search results box 1320 indicates the profile outcome frequencies for “Accept”, “Reject”, and “Review”. FIG. 13 depicts the default view showing statistics for the current day, the previous day, the current week, the current month, and the previous month. Profile transaction totals may be displayed for each time interval. Embodiments of the invention include other time intervals for generating rule profile reports.

### IV. Exemplary Transaction Request Methods

FIG. 14 shows a method of reviewing transactions associated with a rule outcome or rule outcome disposition.

At step 1401, merchant client computer 114 sends a request for transactions associated with a rule outcome or rule outcome disposition to fraud detection system 118. The request for transactions may comprise one or more rule outcomes, rule outcome dispositions, transaction outcomes, transaction outcome dispositions, profile outcomes, or profile outcome dispositions. The request for transactions may be made in any suitable manner. In some embodiments, the request for transactions may be made using a fraud rule report. For example, rule outcome frequencies and rule outcome disposition frequencies in rule profile report 1200 may include hyperlinks, so that if user 112 clicks the hyperlink, a request for transactions will be generated by merchant client computer 114 for transactions associated with the corresponding rule outcome or rule outcome disposition. Specifically, in one embodiment, if user 112 clicks rule outcome frequency value 1234, merchant client computer 114 may send a request for transactions associated with multiple identity changes rule 1219 to fraud detection system 118.

At step 1402, fraud detection system 118 sends transactions associated with the rule outcome or rule outcome disposition to merchant client computer 114. Fraud detection system 118 may retrieve and send the transactions in any suitable manner. In some embodiments, fraud detection system 118 may retrieve the transactions from transaction database 118(N). Fraud detection system 118 may send the transactions to user 112 as a web page, table, or in any other suitable format.

At step 1403, merchant client computer 114 receives and displays the transactions to user 112. In some embodiments, merchant client computer 114 may present a transaction results interface to user 112 to view, modify, and take actions relating to the received transactions. For example, user 112 may select a transaction to view detailed transaction details relating to the transaction. A method of requesting transaction details according to one embodiment of the invention is shown in FIG. 16.

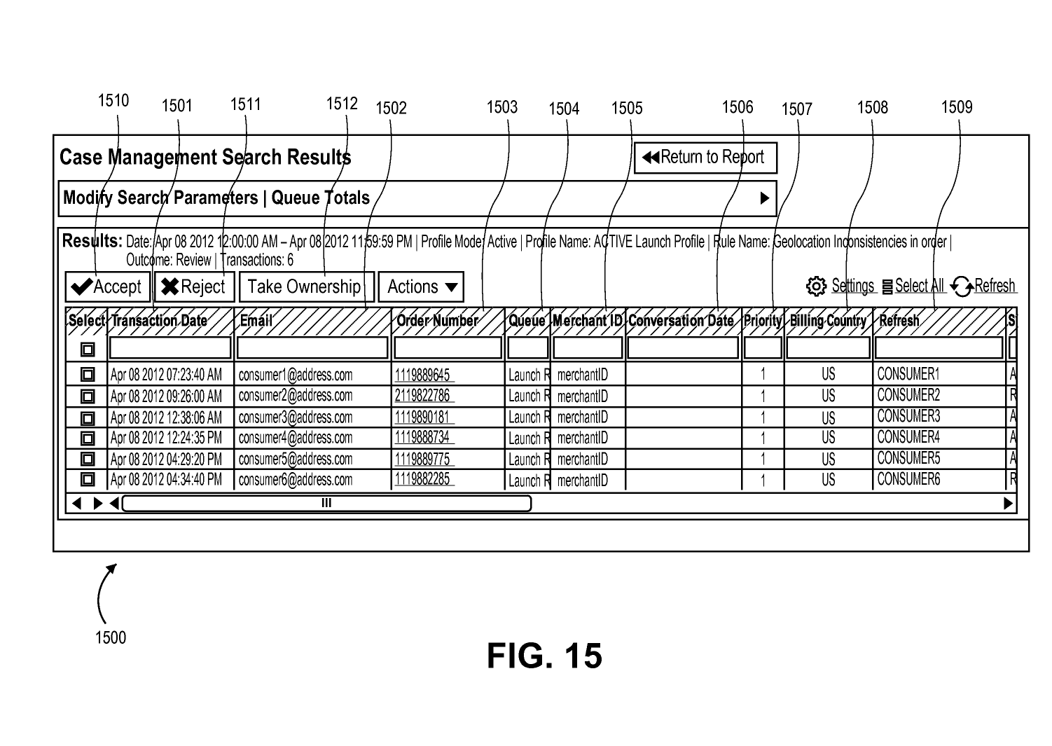

FIG. 15 shows an exemplary transaction results interface 1500. FIG. 135 depicts an exemplary result from a selection by user 112 to view all of the transactions that triggered the review action for the fraud detection rule titled, “Geolocation inconsistencies in order.” For example, in some embodiments, the user may have clicked rule outcome frequency value 1238. In FIG. 15, each of the six transactions that triggered the “review” action for the selected fraud detection rule is displayed. In embodiments of the invention, the data presented for each transaction can include, but is not limited to the transaction date and time 1501, the email address of the consumer 1502, the order number 1503, the queue 1504 (e.g., the rule profile associated with the transaction), the merchant ID 1505, the conversion date 1506, the priority 1507, the billing country 1508, and a consumer identifier 1509. Some embodiments of the invention may include all of the preceding categories of data, a greater number or a fewer number of data fields.

Additional features of the transaction results interface 1500 include buttons to manually accept 1510, reject 1511 or take ownership 1512 of the transactions displayed. For example, since the exemplary transactions shown in transaction results interface 1500 were initially marked for review, the user 112 can review each transaction and mark it as accept, reject, or take ownership of the transaction.

At step 1404, user 112 modifies one or more transactions using merchant client computer 114. User 112 may modify transactions for any suitable reason. For example, user 112 may correct a name, address, or payment information which was incorrectly entered by the consumer. Further, user 112 may change the transaction outcome of a transaction. For example, user 112 may change the transaction outcome for a transaction which was accepted by fraud detection system 118 to “Rejected” in order to manually reject the transaction, or vice versa. In addition, user 112 may assign transaction outcomes to transactions with a current transaction outcome of “Review”. Thus, the interface displayed in step 1403 may be used by user 112 to manually approve or decline transactions for which a transaction outcome of “Review” was previously determined by fraud detection system 118. One the user selects and modifies one or more transaction, at step 1405, merchant client computer 114 submits a transaction modification request to fraud detection system 118.

In the exemplary transaction results interface 1500, user 112 may select one or more transactions. Once user 112 presses accept button 1510, reject button 1511, or take ownership button 1512, merchant client computer 114 may generate a corresponding transaction modification request.

FIG. 16 shows a method to request transaction details for a transaction. In some embodiments of the invention, method 1600 may be initiated by user 112 selecting a transaction in a transaction results interface. Alternately, method 1600 FIG. may be initiated from a reports home page (e.g., by starting a transaction search 1006 as shown in FIG. 10).

At step 1601, merchant client computer 114 sends a request for transaction details for a transaction. The request for transaction details may comprise a transaction identifier, an order number, or any other information suitable for retrieving a transaction.

At step 1602, fraud detection system 118 sends transaction details to merchant client computer 114. In some embodiments, fraud detection system 118 may determine the transaction details using transaction database 118(N).

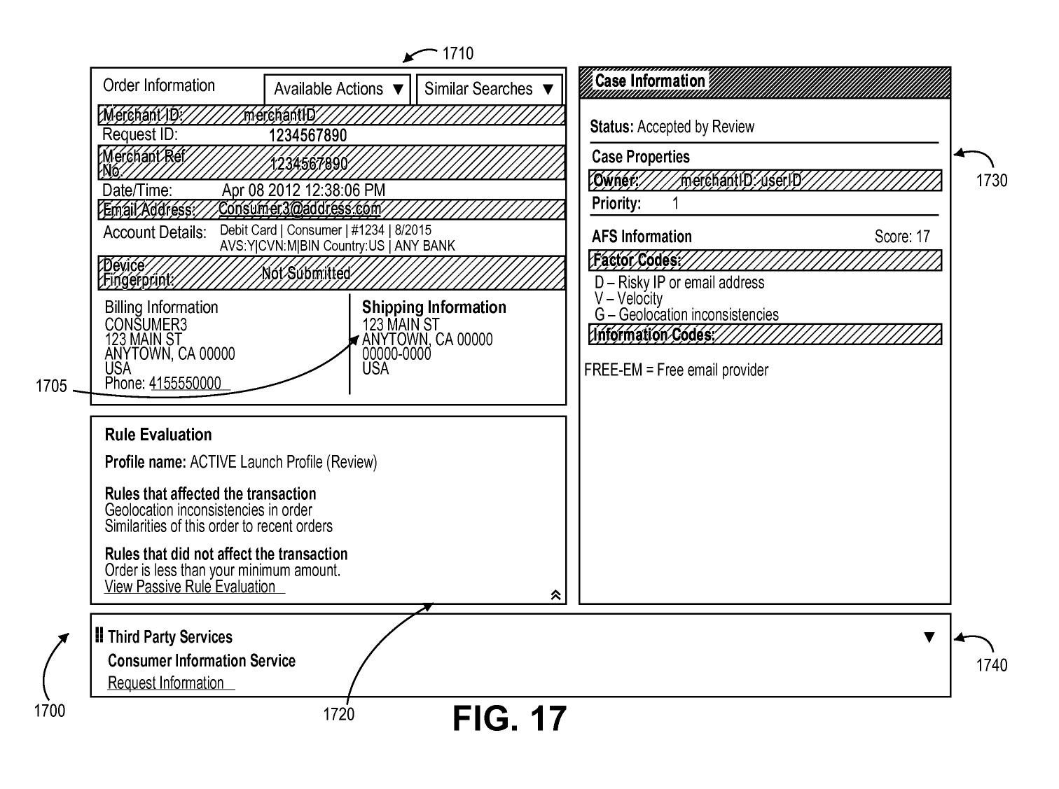

At step 1603, merchant client computer 114 displays the transaction details to the user. The transaction details may comprise merchant information, billing and shipping information, information relating to rule evaluation, information relating the current status of the transaction, and third party service information. At step 1604, user 112 reviews the transaction details using merchant client computer 114. FIG. 17 shows a transaction details interface 1700 for displaying transaction details according to some embodiments of the invention.

Transaction details interface 1700 allows the user 112 to analyze in detail each transaction that triggered a rule. The transaction details interface 1700 includes an order information section 1710, a rule evaluation section 1720, a case information section 1730, and a third party services section 1740. Each of sections 1710, 1720, 1730, and 1740 may include transaction details, such as transaction detail 1705, the street address to which to ship. In embodiments of the invention, additional or fewer sections may be included on the transaction detail page 1700.

The order information section 1710 allows the user 112 to review transaction details relating to order information including the details of the consumer 102 involved in the transaction (e.g. name, billing address, shipping address, telephone number, email address, etc.) as well as the transaction date and time, the method of payment used in the transaction, merchant identifying information, and order identifying information.

The rule evaluation section 1720 provides transaction details relating to rules that affected the transaction and rules that were triggered but that did not affect the transaction. For example, fraud detection rules that were triggered but that did not affect the transaction may have been fraud detection rules set to monitor or may have been passive rules. In the shown example, the selected transaction indicates that two fraud detection rules affected the transaction: “Geolocation inconsistencies in order” and “Similarities of this order to recent orders.” In addition, the fraud detection rule titled “Order is less than your minimum amount” was triggered but did not affect the transaction.

The case information section 1730 shows transaction details relating to factors that led to the transaction being marked for review. The shown example that factors that were considered included risky IP or email address, velocity issues, and geolocation inconsistencies. The case information section 1730 also indicates the status of the transaction. For example, after being reviewed, the transaction was marked as “Accepted by Reviewer.”

The third party services section 1740 shows additional transaction details that the merchant can access from third parties. For example, the merchant can access public records for the consumer who engaged in the transaction. In embodiments, providing access to public records can assist the merchant in making a determination as to whether a transaction is fraudulent. In embodiments, the merchant can be provided with fraud ratings, other consumer reports and records, and any other third party data that can be a factor in determining whether a transaction is fraudulent.

### V. Exemplary Computer Apparatuses

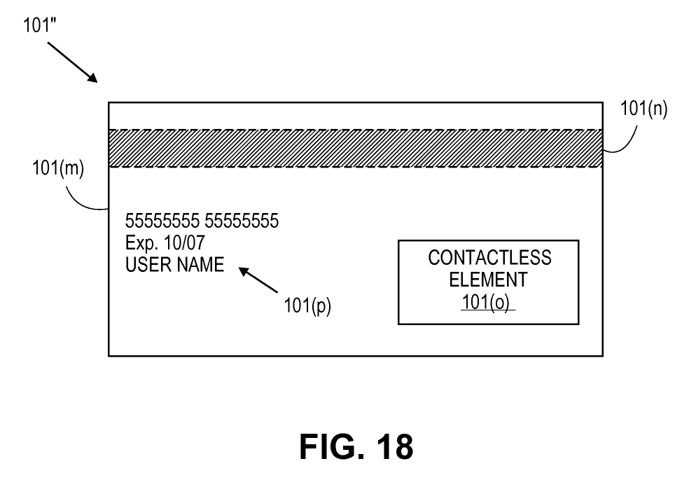

FIG. 18 shows an example of a payment device 101″ in the form of a card. As shown, the payment device 101″ comprises a plastic substrate 101(m). In some embodiments, a contactless element 101(o) for interfacing with an access device 102 may be present on, or embedded within, the plastic substrate 101(m). Consumer information 101(p) such as an account number, expiration date, and/or a user name may be printed or embossed on the card. A magnetic stripe 101(n) may also be on the plastic substrate 101(m). In some embodiments, the payment device 101″ may comprise a microprocessor and/or memory chips with user data stored in them.

As noted above and shown in FIG. 18, the payment device 101″ may include both a magnetic stripe 101(n) and a contactless element 101(o). In some embodiments, both the magnetic stripe 101(n) and the contactless element 101(o) may be in the payment device 101″. In some embodiments, either the magnetic stripe 101(n) or the contactless element 101(o) may be present in the payment device 101″.

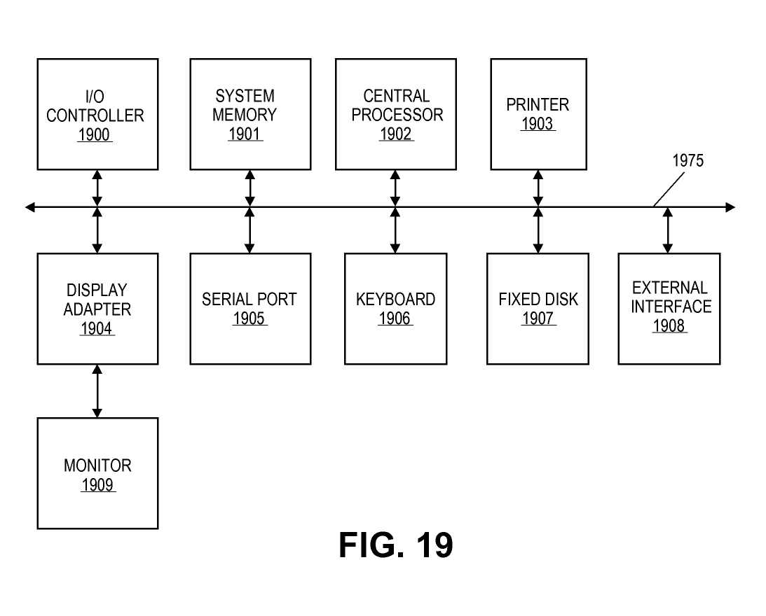

FIG. 19 is a high level block diagram of a computer system that may be used to implement any of the entities or components described above. The subsystems shown in FIG. 19 are interconnected via a system bus 1975. Additional subsystems include a printer 1903, keyboard 1906, fixed disk 1907, and monitor 1909, which is coupled to display adapter 1904. Peripherals and input/output (I/O) devices, which couple to I/O controller 1900, can be connected to the computer system by any number of means known in the art, such as a serial port. For example, serial port 1905 or external interface 1908 can be used to connect the computer apparatus to a wide area network such as the Internet, a mouse input device, or a scanner. The interconnection via system bus 1975 allows the central processor 1902 to communicate with each subsystem and to control the execution of instructions from system memory 1901 or the fixed disk 1907, as well as the exchange of information between subsystems. The system memory 1901 and/or the fixed disk may embody a computer-readable medium.

### VI. Additional Embodiments

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A computer-implemented method comprising:
determining, by a processor, a rule profile, wherein the rule profile comprises a plurality of rules, and wherein each rule in the plurality of rules is associated with a plurality of rule outcomes;
for the plurality of rules, determining, by the processor, a plurality of rule outcome frequencies associated with the plurality of rule outcomes, wherein each rule outcome in the plurality of rule outcomes is associated with an outcome for a transaction; and
providing, by the processor, the plurality of rule outcome frequencies.

2. The method of claim 1, further comprising receiving, from the client computer, one or more search parameters, wherein the search parameters are used to determine the rule profile.

3. The method of claim 1, wherein the rule profile is a fraud rule profile, wherein each of the plurality of rules is a fraud rule, and wherein each rule outcome in the plurality of rule outcomes is associated with an authorization status of a transaction.

4. The method of claim 3, further comprising receiving, from a client computer, a request for transactions associated with a rule outcome; and sending, to the client computer, one or more transactions associated with the rule outcome.

5. The method of claim 4, further comprising receiving, from the client computer, a request for transaction details for a transaction in the transactions associated with the rule outcome; and sending the transaction details.

6. The method of claim 1, wherein each rule is further associated with a plurality of rule outcome dispositions, and wherein the method further comprises: for the plurality of rules, determining, by the processor, a plurality of rule outcome disposition frequencies associated with the plurality of rule outcome dispositions, respectively; and providing, by the processor, the plurality of rule outcome disposition frequencies.

7. A server computer, comprising:
a processor; and
a non-transitory computer-readable storage medium, comprising code executable by the processor for implementing a method comprising:
determining, by a processor, a rule profile, wherein the rule profile comprises a plurality of rules, and wherein each rule in the plurality of rules is associated with a plurality of rule outcomes;
for the plurality of rules, determining, by the processor, a plurality of rule outcome frequencies associated with the plurality of rule outcomes, respectively, wherein each rule outcome in the plurality of rule outcomes is associated with an outcome for a transaction; and
providing, by the processor, the plurality of rule outcome frequencies.

8. The server computer of claim 7, wherein the method further comprises: receiving, from the client computer, one or more search parameters, wherein the search parameters are used to determine the rule profile.

9. The server computer of claim 7, wherein the rule profile is fraud rule profile, wherein each rule outcome in the plurality of rules is a fraud rules, and wherein the plurality of rule outcomes is associated with the authorization status of a transaction.

10. The server computer of claim 9, wherein the method further comprises: sending, to a client computer, one or more transactions associated with a rule outcome; and sending, to the client computer, transaction details for a transaction in the one or more transactions associated with the rule outcome.

11. A computer-implemented method comprising:
sending, by a processor, one or more search parameters, wherein the one or more search parameters are used to determine a rule profile, wherein the rule profile comprises a plurality of rules, and wherein each rule in the plurality of rules is associated with a plurality of rule outcomes;
receiving, by the processor, a plurality of rule outcome frequencies associated with the plurality of rule outcomes, wherein each rule outcome in the plurality of rule outcomes is associated with an outcome of a transaction; and
displaying, by the processor, the plurality of rules and rule outcome frequencies.

12. The method of claim 11, wherein the method further comprises: sending a request for transactions associated with a first rule outcome; and receiving, by the processor, one or more transactions associated with the first rule outcome.

13. The method of claim 12, wherein the method further comprises: accepting or rejecting a transaction in the one or more transactions associated with the rule outcome.

14. The method of claim 12, further comprising: sending a request for transaction details for a transaction in the one or more transactions; and receiving the transaction details.

15. The method of claim 11, wherein the method further comprises: receiving, by the processor, a plurality of rule outcome disposition frequencies; and
displaying the plurality of rule outcome disposition frequencies.

16. A computer, comprising:
a processor; and
a non-transitory computer-readable storage medium, comprising code executable by the processor for implementing a method comprising:
sending, by a processor, one or more search parameters, wherein the search parameters are used to determine a rule profile, wherein the rule profile comprises a plurality of rules, and wherein each rule in the plurality of rules is associated with a plurality of rule outcomes;
receiving, by the processor, a plurality of rule outcome frequencies associated with the plurality of rule outcomes, wherein each rule outcome in the plurality of rule outcomes is associated with the outcome of a transaction; and
displaying, by the processor, the plurality of rule outcome frequencies.

17. The method of claim 16, wherein the method further comprises: sending a request for transactions associated with a rule outcome; and receiving, by the processor, one or more transactions associated with the rule outcome.

18. The method of claim 17, wherein the method further comprises: accepting or rejecting a transaction in the one or more transactions associated with the rule outcome.

19. The method of claim 17, further comprising: sending a request for transaction details for a transaction in the one or more transactions; and receiving the transaction details.

20. The computer of claim 16, wherein the method further comprises: receiving, by the processor, a plurality of rule outcome disposition frequencies; and displaying the plurality of outcome disposition frequencies.
